(19) United States
(12) Patent Application Publication
(10) Pub. No.: US 2026/0289583 A1
(43) Pub. Date: Sep. 24, 2026

(54) SYSTEM

(71) Applicant: SoftBank Group Corp., Tokyo (JP)

(72) Inventor: Stacy WANG, Tokyo (JP)

(73) Assignee: SoftBank Group Corp., Tokyo (JP)

(21) Appl. No.: 19/558,525

(22) Filed: Mar. 6, 2026

(30) Foreign Application Priority Data
Mar. 19, 2025 (JP) 2025-044486

(51) Int. Cl. G06Q 30/018; G06N 3/0475; G06Q 10/0635

(52) U.S. Cl. CPC G06Q 30/018; G06N 3/0475; G06Q 10/0635

(57) ABSTRACT

A system includes a processor that is configured to receive information from a user, generate a prompt for instructing a generative AI model to analyze the received information, input the prompt into the generative AI model, analyze a response from the generative AI model, and evaluate a possibility of a compliance violation on a basis of evaluation criteria for evaluating the possibility of the compliance violation.

### CROSS-REFERENCE TO RELATED APPLICATION

This application is based on and claims priority under 35 USC 119 from Japanese Patent Application No. 2025-044486 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional compliance support systems typically rely on static rule sets, manual search of internal policies, or simple keyword-based decision trees. Such systems often fail to appropriately interpret natural language descriptions provided by users, and therefore cannot accurately evaluate a possibility of compliance violations in complex or ambiguous situations. In addition, these systems generally do not provide context-specific violation examples or tailored countermeasures derived from generative artificial intelligence models, which limits the user's understanding of potential risks and appropriate responses. As a result, there is a need for a system that can dynamically analyze user-provided information using a generative AI model, evaluate a possibility of compliance violations based on predetermined evaluation criteria, and present concrete violation cases and suitable countermeasures through an interactive user interface.

### SUMMARY

In order to solve the above-described problems, an embodiment of the present invention provides a system comprising a processor, wherein the processor is configured to receive information from a user, to generate a prompt for instructing a generative AI model to analyze the received information, to input the prompt into the generative AI model, to analyze a response from the generative AI model, and to evaluate a possibility of a compliance violation on the basis of evaluation criteria for evaluating the possibility of the compliance violation. The processor is further configured to generate, on the basis of the information from the user, a prompt for instructing the generative AI model to generate a violation case, to input the prompt into the generative AI model, to generate a case by using data obtained from the generative AI model, and to cause the case to be displayed via a user interface. The processor is also configured to generate, on the basis of the information from the user, a prompt for instructing the generative AI model to propose a countermeasure, to input the prompt into the generative AI model, to analyze a response obtained from the generative AI model, and to generate the countermeasure. By these means, the system enables automatic and context-aware evaluation of compliance risks, presentation of concrete violation examples, and provision of appropriate countermeasures tailored to the user's situation.

The term “system” refers to an arrangement of hardware and software components, including at least one processor and optionally memory, storage, communication interfaces, and a user interface, that cooperatively perform the functions described in the claims.

The term “processor” refers to a hardware processing unit, such as a central processing unit (CPU), a graphics processing unit (GPU), a microprocessor, or a combination thereof, that executes instructions to perform the processing operations described in the claims.

The term “user” refers to a human operator, such as an employee, manager, compliance officer, or other person, who provides information to the system and receives information or guidance from the system.

The term “user interface” refers to any hardware and software mechanism that enables interaction between the user and the system, including but not limited to a graphical user interface on a display, a web browser interface, a mobile application interface, or a command-line interface.

The term “information from a user” refers to any data provided by the user to the system, including but not limited to natural language text, structured form inputs, selections, or other inputs describing a situation, contemplated action, question, or context related to compliance.

The term “generative AI model” refers to a machine learning model, such as a large language model or other generative model, that is configured to generate text or other data in response to input prompts, based on training data and learned parameters.

The term “prompt” refers to data generated by the processor and provided as input to the generative AI model, the data including instructions, questions, or contextual information that cause the generative AI model to perform a desired analysis, generation of violation cases, or proposal of countermeasures.

The term “response from the generative AI model” refers to output data produced by the generative AI model in response to a prompt, the output data including, for example, analysis results, generated examples, explanations, or proposed countermeasures.

The term “analyze” refers to processing performed by the processor on data, including parsing, classifying, extracting features, interpreting content, and deriving structured information or evaluations from the data.

The term “evaluate a possibility of a compliance violation” refers to determining, by the processor, a likelihood, risk level, or qualitative judgment as to whether a described situation or contemplated action may violate a compliance requirement, policy, law, regulation, or internal rule.

The term “evaluation criteria” refers to one or more rules, thresholds, models, parameters, or reference data used by the processor to judge or score the possibility of a compliance violation based on the analysis of the response from the generative AI model and the information from the user.

The term “violation case” refers to an example, scenario, or description of conduct that constitutes, or is treated as, a compliance violation, the example being generated or formed by using data obtained from the generative AI model.

The term “generate a case” refers to creating, by the processor, a representation of a violation case, including at least a description of the circumstances, actions, and compliance issues, based on data obtained from the generative AI model.

The term “countermeasure” refers to an action, procedure, recommendation, or policy-compliant response proposed to prevent, mitigate, correct, or appropriately handle a potential or actual compliance violation.

The term “propose a countermeasure” refers to causing, by the processor, the generative AI model to output one or more recommended actions or responses for addressing a potential compliance issue, and forming, by the processor, a countermeasure based on the output.

The term “cause the case to be displayed” refers to controlling, by the processor, the user interface so that a generated violation case is presented in a human-perceivable form, such as text, graphics, or a combination thereof, on a display or other output device.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

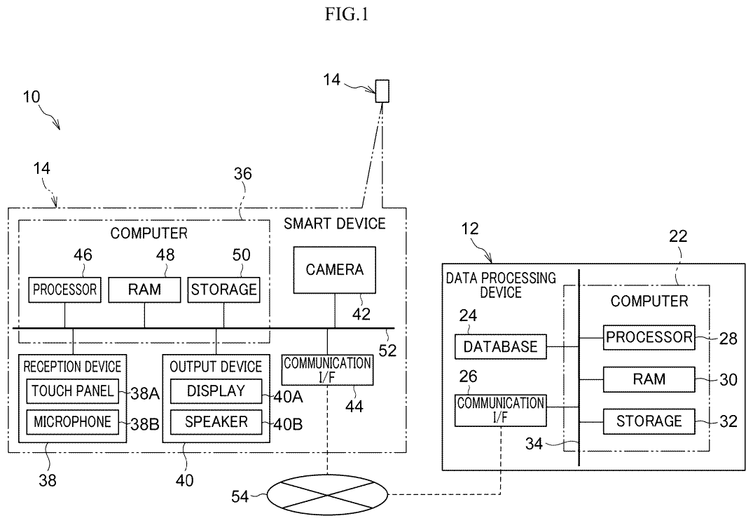

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

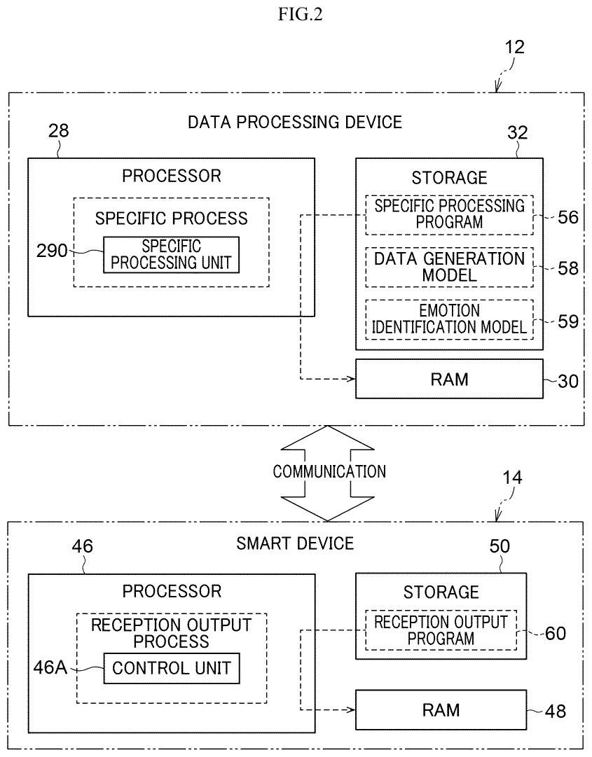

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented compliance support systems primarily rely on fixed rule sets, manually curated checklists, or keyword-based matching to analyze user-reported situations. Such systems suffer from several technical shortcomings. First, because the evaluation logic is hard-coded and static, the systems cannot flexibly interpret complex natural language descriptions of workplace situations, which leads to low recall and precision in detecting potential compliance risks. Second, the systems typically process input text in a monolithic manner, without generating structured intermediate data, such as risk indices, risk categories, or machine-usable explanations, thereby limiting subsequent automated processing and integration with other subsystems. Third, conventional systems do not effectively integrate heterogeneous data sources, such as internal regulations, dynamic outputs of a generative AI model, and a case database of past incidents, in a unified, machine-processable evaluation pipeline. This results in fragmented processing, inconsistent evaluations, and high maintenance costs for updating rules.

Moreover, many existing implementations treat a generative AI model, if used at all, merely as a black-box text generator invoked on an ad hoc basis. These implementations do not provide a systematic mechanism, at the processor level, to (i) construct structured prompt sentences that specify evaluation requests, desired output formats, and required risk indicators, (ii) parse and validate the structured output of the model, (iii) algorithmically combine the model output with regulation information and similarity-based retrieval of past cases, and (iv) transform the combined evaluation into a stable, standardized data representation for user interface rendering. As a result, such systems often exhibit unpredictable behavior, poorly controlled output formats, and difficulties in error handling and traceability.

From a computer technology standpoint, there is also a problem in that server-side resources are not efficiently utilized to perform multi-stage analysis that includes storage of raw situation information, generation of feature quantities, similarity calculations over case data, and threshold-based risk evaluation, all orchestrated around calls to a generative AI model. Without a clearly defined processing pipeline integrating these steps, the system cannot reliably scale, cannot guarantee consistent latency, and cannot provide reproducible evaluations. Furthermore, existing systems lack a mechanism for the server to automatically adaptively enrich the evaluation result with relevant internal regulations and past cases, so that downstream user interface components can present complete, context-rich information without additional ad hoc processing.

Accordingly, there is a need for a computer-implemented system and method that improves the technical operation of a compliance evaluation server by: (i) programmatically generating and managing prompt sentences for a generative AI model based on received situation information, (ii) extracting and validating structured risk-related data from responses of the generative AI model, (iii) algorithmically combining the structured data with regulation information and similarity-based retrieval of past cases, and (iv) automatically generating standardized, machine-processable evaluation result data for presentation on a user terminal. Such a system would improve the accuracy, robustness, scalability, and maintainability of compliance evaluation processing performed by computer systems, thereby improving the underlying computer technology itself.

The specific processing by the specific processing unit 290 of the data processing device 12 in Example 1 is realized by the following means.

The present invention provides a server comprising a processor and one or more storage devices, the processor being configured to receive, via a communication line, situation information in text form from a user terminal, store the situation information in association with identification information and time information in a first storage device, verify whether the situation information satisfies a predetermined input condition, generate, based on the situation information, a prompt sentence including an evaluation request, an output format, a risk index, and recommended action information for evaluating a possibility of a compliance violation, generate input data by combining the prompt sentence with the situation information, output the input data together with instruction information for transmission of the input data to a generative AI model executed by an external processing device, acquire response data from the generative AI model, extract, from the response data, the risk index, a risk category, reason information, related policy categories, and the recommended action information, perform an evaluation process for determining whether the risk index satisfies a predetermined threshold condition, search regulation information stored in a regulation information storage device based on the related policy categories, generate evaluation result data by adding the regulation information to the response data, generate a feature quantity corresponding to contents of the situation information, perform a similarity calculation between the feature quantity and feature quantities of past cases stored in a case information storage device, extract past cases having a similarity satisfying a predetermined condition, generate extended evaluation result data by adding summary information and outcome information regarding the past cases to the evaluation result data, convert the extended evaluation result data into user interface output data, and transmit the user interface output data to the user terminal for visual presentation of at least the risk index, the risk category, the reason information, related regulation information, past case information, and the recommended action information. This enables the server to implement a structured, multi-stage compliance evaluation pipeline that programmatically controls prompt sentence generation for the generative AI model, converts unstructured natural language responses into validated, structured risk data, and algorithmically integrates regulation information and similarity-based past case retrieval to produce standardized evaluation outputs, thereby improving the accuracy, consistency, and computational efficiency of compliance analysis performed by the computer system.

The term “processor” refers to a hardware or virtual computing element, such as a central processing unit or a processing core, configured to execute program instructions to perform operations including receiving data, generating prompt sentences, invoking a generative AI model, performing evaluations, and generating output data.

The term “storage device” refers to a non-transitory computer-readable medium, such as a magnetic disk, semiconductor memory, or solid-state drive, configured to store situation information, regulation information, past case information, and evaluation result data.

The term “communication line” refers to a wired or wireless communication path, including a local area network, a wide area network, or the Internet, through which data is transmitted between the server, the user terminal, and an external processing device.

The term “user terminal” refers to an information processing device, such as a personal computer, a portable terminal, or a smartphone, operated by a user to input situation information and to receive and display evaluation results.

The term “situation information” refers to text data representing a description of a workplace situation or event provided by a user for the purpose of evaluating a possibility of a compliance violation.

The term “identification information” refers to data that uniquely or logically identifies an entity related to the situation information, such as a user identifier, a terminal identifier, or a request identifier.

The term “time information” refers to data indicating a time associated with the situation information, such as a timestamp representing a creation time or a reception time.

The term “input condition” refers to one or more criteria used to verify that the situation information is suitable for processing, including conditions on presence of text, length, format, or completeness.

The term “prompt sentence” refers to text data generated by the processor, which specifies an evaluation request, required output format, risk indicators, and recommended action information, and is provided as input to a generative AI model together with the situation information.

The term “evaluation request” refers to a description within the prompt sentence that instructs the generative AI model to analyze the situation information and to generate output relating to compliance risk and associated information.

The term “output format” refers to a specification within the prompt sentence that defines the structure or schema of a response to be generated by the generative AI model, including fields such as risk index, risk category, reasons, and recommended actions.

The term “risk index” refers to quantitative data, such as a numerical value within a predetermined range, representing a degree or probability of a compliance violation indicated by the situation information.

The term “recommended action information” refers to data representing one or more suggested responses or countermeasures for the user to take in relation to a potential compliance violation indicated by the situation information.

The term “input data” refers to a combined data structure including at least the prompt sentence and the situation information, which is transmitted from the processor to the generative AI model.

The term “instruction information” refers to control data provided by the processor to an external processing device, instructing the external processing device to execute the generative AI model on the input data.

The term “generative AI model” refers to a trained artificial intelligence model, such as a neural network-based language model, configured to generate text or structured output in response to input text according to learned patterns.

The term “external processing device” refers to a computing apparatus, distinct from the server and accessible via a communication line, which executes the generative AI model and returns response data to the server.

The term “response data” refers to data output by the generative AI model in response to the input data, including at least a risk index, a risk category, reasons, policy-related information, and recommended actions.

The term “risk category” refers to classification data indicating a qualitative level of compliance risk, such as low, medium, or high, associated with the situation information.

The term “reason information” refers to explanatory data generated by the generative AI model or the processor, indicating grounds or factors for the risk index or risk category.

The term “related policy categories” refers to categorical data indicating one or more areas of internal regulations or external laws, such as data protection or information security, that are relevant to the situation information.

The term “threshold condition” refers to one or more criteria specifying how the risk index is to be compared with a predetermined value or range for determining whether a particular risk state is satisfied.

The term “regulation information storage device” refers to a storage device that stores regulation information including internal policies, guidelines, and external legal provisions used for compliance evaluation.

The term “regulation information” refers to structured or semi-structured data representing rules, policies, standards, or legal requirements applicable to operations within an organization.

The term “evaluation result data” refers to data generated by the processor that combines at least the response data of the generative AI model with regulation information to represent a compliance evaluation in a structured form.

The term “feature quantity” refers to numerical or symbolic data, such as a vector representation, derived from the situation information and used for similarity calculation with past cases.

The term “case information storage device” refers to a storage device that stores data regarding past cases, including descriptions, feature quantities, summaries, and outcome information used for similarity-based retrieval.

The term “past case” refers to stored data representing a previous situation, incident, or example, including its description and outcome, which is used as a reference for evaluating a current situation.

The term “similarity calculation” refers to a computational process that quantifies the similarity between the feature quantity derived from the situation information and feature quantities associated with past cases, using a metric such as cosine similarity or distance.

The term “summary information” refers to condensed descriptive data about a past case, including key facts and essential elements, generated or stored for efficient presentation and processing.

The term “outcome information” refers to data representing a result or consequence of a past case, including determinations of violation, sanctions, remedial actions, or resolutions.

The term “extended evaluation result data” refers to evaluation result data augmented by adding at least summary information and outcome information of one or more past cases selected based on similarity.

The term “user interface output data” refers to data formatted for presentation on a display device of the user terminal, including layout, labels, and values for risk, reasons, regulations, past cases, and recommended actions.

The term “visual presentation” refers to graphical or textual display of information on a screen or similar output device, enabling a user to perceive risk indices, categories, explanations, regulations, past cases, and recommended actions.

In an embodiment, a server comprises a processor, a main memory, a non-transitory storage device, and a network interface. The server is connected via a communication line, such as a wired or wireless IP network, to one or more terminals operated by users and to an external processing device executing a generative AI model. The terminal comprises a processor, a memory, a display, an input device, and a communication interface. The user operates the terminal to input text describing a real-world workplace situation and to receive compliance evaluation results.

The server executes an operating system, such as a general-purpose server operating system, and an application program implementing the compliance evaluation functions described in the claims. The application program is stored in the storage device and loaded into the main memory for execution by the processor. The application program is configured to control the network interface, the storage device, and other resources to implement the described data structures, algorithms, and interactions with the generative AI model.

The terminal executes a browser or a dedicated client application. The terminal displays a user interface screen including at least a text input area, a send button, and an area for presenting an evaluation result. The user inputs situation information, such as:

“My supervisor instructed me to send a spreadsheet containing all customer phone numbers and email addresses to an external marketing agency.”

The terminal transmits the situation information to the server using a secure transport protocol, such as HTTPS over TLS. The terminal may attach a user identifier, a terminal identifier, and a timestamp. The terminal may also perform preliminary validation, such as checking that the input length does not exceed a maximum character count.

The server receives the situation information through the network interface. The server stores the situation information in the storage device in association with identification information and time information. The server uses a structured data schema, such as a table in a relational database or a document in a document-oriented database, defining fields including, for example, request_id, user_id, situation_text, created_at, and status. The server verifies that the situation information satisfies one or more input conditions, such as a minimum length, a maximum length, a permitted character set, and the presence of at least one verb and one noun, using a text analysis routine implemented in the application program. This verification prevents malformed or trivial inputs from consuming computational resources of the generative AI model and ensures that the generative AI model receives text suitable for meaningful analysis, thereby improving overall computational efficiency.

The server generates a prompt sentence based on the situation information. The server uses a template mechanism in which a base prompt sentence is stored in the storage device as a parameterized string. The server inserts parameters such as requested output fields, risk index definitions, and policy categories into the base template. In an embodiment, the server generates a prompt sentence such as:

“You are a corporate compliance analysis engine. Analyze the following workplace situation. Evaluate whether the situation is likely to involve a compliance violation. Consider at least data protection, information security, anti-bribery, harassment, and conflict of interest. Provide your answer in a machine-readable JSON-like structure with the following fields: risk_score (a real number between 0.0 and 1.0), risk_level (one of “low”, “medium”, “high”), reasons (a list of brief textual explanations), policy_areas (a list of applicable policy areas), and recommendations (a list of concrete next actions for the employee). Situation: [user situation text]”

The server replaces “[user situation text]” with the actual situation information. The server thereby constructs a prompt sentence that explicitly constrains the output structure and the semantic content to be produced by the generative AI model. By generating and enforcing a structured prompt sentence, the server ensures that the generative AI model produces output that can be deterministically parsed and validated. This improves the reliability and predictability of the computer processing, distinguishing the system from mere free-form text generation.

The server transmits input data, including the prompt sentence and the situation information, to the generative AI model. The server uses a client library implementing an HTTP protocol to send the input to the external processing device. The server sets parameters such as model identifier, temperature, maximum token count, and response format constraints. In an embodiment, the generative AI model is a transformer-based neural network having multiple self-attention layers and feed-forward layers. The model receives a tokenized representation of the prompt sentence and the situation information, maps tokens to vector embeddings, processes the embeddings through stacked attention blocks, and generates output tokens representing the requested risk index, risk level, reasons, and other structured fields. The external processing device computes the output using specialized hardware such as general-purpose GPUs, which accelerate matrix multiplications and attention operations.

The generative AI model is trained in advance using a machine learning procedure in which large-scale text data, including compliance-related documents and annotated examples, are provided as training samples. During training, the model parameters, including weight matrices in attention layers and feed-forward layers, are updated by an optimization algorithm such as stochastic gradient descent or Adam. A loss function, such as cross-entropy between predicted token distributions and ground truth tokens, is minimized. Training may also include supervised fine-tuning on domain-specific compliance examples, where labels such as risk levels, policy areas, and recommended actions are explicitly provided. The model uses positional encodings, multi-head attention heads, and layer normalization to improve convergence and generalization. Data augmentation techniques, such as paraphrasing inputs or adding noise, may be applied during training to enhance robustness to linguistic variations.

The server receives response data from the generative AI model. The response data contains text representing a structured output that follows the requested format. The server parses the response text into an internal data structure using a robust parsing routine that tolerates minor deviations from the expected syntax. The server extracts a risk index, a risk category, reason information, related policy categories, and recommended action information. The server validates that the risk index lies within a specified numeric range and that the risk category matches one of the permitted values. The server rejects or corrects outputs that do not pass validation and, in such cases, may re-issue a modified prompt sentence that explicitly instructs the generative AI model to correct the format. This interaction pattern yields a stable and machine-usable representation in memory, thereby improving the determinism and reproducibility of the computer's behavior.

The server searches regulation information stored in a regulation information storage device based on the related policy categories extracted from the response data. The regulation information storage device stores internal policy documents and legal references in a structured format. For example, each record may include fields such as policy_area, policy_id, article_number, summary, and reference_url. The server executes a search query that filters records by policy_area matching the related policy categories and retrieves relevant articles. The server then combines the response data of the generative AI model with the retrieved regulation information to generate evaluation result data. The evaluation result data is stored in a structured form, such as a JSON-like object or a relational record, containing at least the risk index, risk category, reasons, policy areas, and links to specific regulations.

The server generates a feature quantity corresponding to the contents of the situation information. In an embodiment, the server uses an embedding model that maps text to a high-dimensional numeric vector. The server normalizes the text, tokenizes the text, and processes the tokens through the embedding model to generate a vector. The embedding model may be a neural network trained with a contrastive objective or a masked language modeling objective, configured to place semantically similar texts close in the vector space. The server stores the resulting feature quantity in association with the corresponding request.

The server stores past cases in a case information storage device. Each past case record includes a situation description, a pre-computed feature quantity, a summary of the case, and an outcome indicating, for example, whether a violation was confirmed and what corrective actions were taken. The server performs a similarity calculation between the feature quantity derived from the current situation information and the feature quantities of past cases, using a similarity metric such as cosine similarity. The server identifies one or more past cases whose similarity exceeds a predetermined threshold or ranks cases and selects a top-ranked subset. The server then retrieves summary information and outcome information for the selected past cases and adds this information to the evaluation result data to generate extended evaluation result data.

By computing feature quantities and similarity scores on the server, and by storing and indexing vector representations in an efficient data structure such as a vector index or a specialized vector database, the server minimizes redundant computation across multiple requests, reduces search time for similar cases, and improves scalability when the number of stored cases increases. This achieves a technical improvement in data management and retrieval performance in comparison with systems relying solely on keyword matching or manual browsing.

The server converts the extended evaluation result data into user interface output data. The server maps internal field names and values to labels, visual indicators, and display layouts. For example, the server may map a “high” risk category to a red visual indicator and “medium” or “low” risk categories to different color codes. The server also formats the list of reasons, regulation references, and past cases into sections appropriate for the display size of the terminal. The server then transmits the user interface output data to the terminal over the communication line.

The terminal receives the user interface output data and updates the user interface. The terminal displays, on the display device, at least the risk index, risk category, reasons, related regulation information, past case summaries, and recommended actions. The user can read the information and, if desired, perform additional interactions, such as selecting a specific past case to view more details or requesting a re-evaluation. The terminal may cache the user interface output data to allow the user to revisit the evaluation without re-querying the server, thereby reducing network load.

In an embodiment, the server generates different prompt sentences depending on system state or user requirements. For example, when the server determines that the risk index is above a high-risk threshold, the server may generate a second prompt sentence such as:

“Based on the following high-risk situation, generate one or more concrete example scenarios illustrating similar past violations and describe typical organizational responses. Focus on personal data leakage and unauthorized data sharing. Situation: [user situation text]”

In another embodiment, the server generates a prompt sentence explicitly requesting countermeasures, such as:

“Given the following workplace situation, propose specific actionable steps the employee should take to address potential compliance issues. Prioritize steps that involve consulting internal compliance, preserving evidence, and avoiding further violations. Situation: [user situation text]”

The server uses these alternative prompt sentences to obtain specialized outputs from the generative AI model. The server then structures, parses, and integrates these outputs into the extended evaluation result data. Because the prompt sentences explicitly constrain the type and structure of the data requested, the generative AI model is guided to produce machine-usable outputs rather than free-form narrative text. The server's control over the prompt sentences and subsequent parsing logic leads to a reproducible and machine-optimized pipeline in which the generative AI model behaves as a controlled computational component within the larger system.

The server improves computer technology in several ways. First, the server reduces processing time and computational waste by validating inputs and rejecting unsuitable text before invoking the generative AI model, thereby decreasing the number of expensive model calls. Second, the server increases accuracy and stability of evaluation results by using structured prompt sentences and strict response validation, which reduces variability in outputs and parsing errors. Third, the server improves data management by storing situation information, regulation information, and past cases in distinct, well-defined data structures, and by using vector-based similarity search to efficiently retrieve relevant past cases. Fourth, the server reduces communication overhead by transmitting compact, structured user interface output data rather than raw model outputs, which minimizes data volume between the server and the terminal.

The generative AI model processes input sequences in a non-human, algorithmically constrained manner using high-dimensional vector representations and learned weight matrices. The model does not simply emulate human reasoning but follows a deterministic computational graph involving token embeddings, attention heads, linear transformations, and non-linear activation functions. The server's orchestration of this model, together with the generation of prompt sentences and post-processing of outputs, constitutes a particular machine-implemented procedure that is not a mere automation of human mental steps. Instead, the system exploits the ability of the neural network to represent complex language patterns as numeric features and to produce structured outputs under programmatic control, thereby enhancing the underlying information processing capabilities of the computer system.

In an alternative embodiment, the generative AI model is executed locally on the same server rather than on an external processing device. In such a case, the server allocates GPU resources installed in the server chassis to execute the model. The server still generates prompt sentences and input data as described above, but the model execution is invoked via a local inference engine. This configuration reduces network latency between the application logic and the model computation, further improving response time and throughput.

In another embodiment, the server employs multiple generative AI models. For example, a first model is used to compute risk indices and risk categories, while a second model is used to generate human-readable explanations and countermeasures. The server coordinates both models by generating different prompt sentences and by feeding outputs from the first model as context to the second model. The server thereby decomposes the problem into separate sub-tasks aligned with the strengths of each model, improving both computational efficiency and explanatory quality.

In yet another embodiment, the server adapts the threshold conditions and selection rules for past cases based on historical performance data. The server may log user feedback indicating whether the presented evaluation and recommendations were useful or accurate. The server uses this feedback to adjust threshold values for risk indices and similarity scores or to re-rank retrieved past cases. By doing so, the server continuously improves the technical behavior of the evaluation pipeline, reducing false positives and false negatives over time.

Through these embodiments, the server, the terminal, and the generative AI model cooperate to realize a concrete technical system that processes, stores, evaluates, and presents compliance-related information using specific data structures, algorithms, and hardware resources. The system improves the operation of the computer itself, including processing speed, accuracy, data management, and communication efficiency, and is not limited to abstract organizational policies or human decision-making processes.

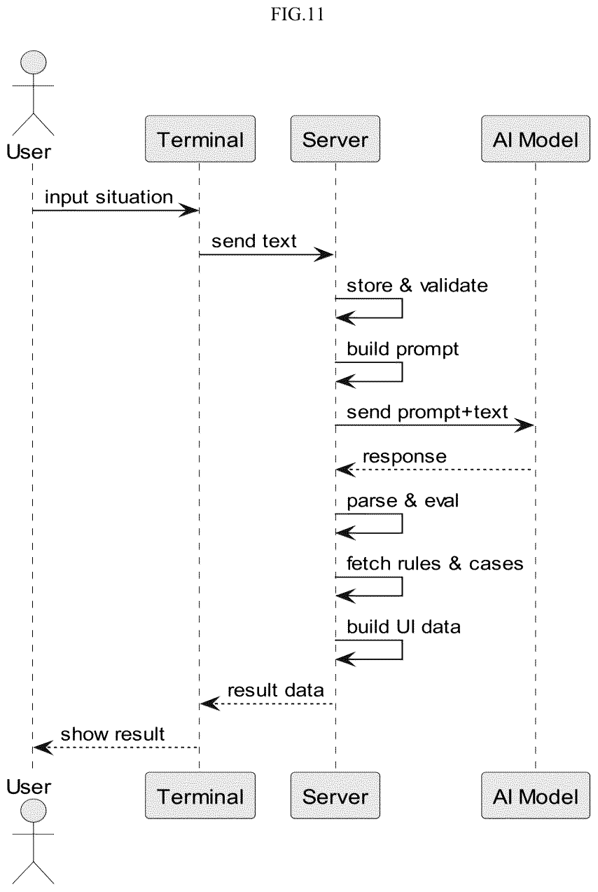

The following describes the processing flow using FIG. 11.

### Step 1

The user operates the terminal to input situation information. The user launches an application or browser on the terminal, opens a compliance evaluation screen, and types a natural language description of a workplace situation into a text input field. The input of this step is the user's raw text, such as “My supervisor instructed me to send a spreadsheet containing all customer contact data to an external marketing agency.” The output of this step is a validated text string stored in the terminal's memory. The terminal checks that the text is not empty, trims leading and trailing whitespace, and confirms that the length is within a predefined limit.

### Step 2

The terminal transmits the situation information to the server. The input of this step is the validated text string and associated metadata such as a user identifier, a terminal identifier, and a local timestamp. The terminal constructs a structured request message that includes these fields and sends the message to the server via HTTPS using the terminal's communication interface. The output of this step is a network packet containing the structured request, which is delivered to the server over a communication line.

### Step 3

The server receives and stores the situation information. The input of this step is the structured request message received through the server's network interface. The server parses the message, extracts fields such as the situation text and identifiers, and writes a new record into a request table or collection in a storage device. The server associates a generated request ID and a reception timestamp with the situation text. The data processing performed by the server includes syntactic validation of the JSON or other structured format and insertion of the extracted values into database fields. The output of this step is a stored request record having a status such as “received.”

### Step 4

The server verifies that the situation information satisfies input conditions. The input of this step is the situation text retrieved from the stored request record. The server executes a validation routine that checks conditions such as minimum character length, maximum character length, permitted character sets, and absence of disallowed control characters. Optionally, the server performs a lightweight natural language analysis, such as part-of-speech tagging, to confirm that the text includes at least one verb and one noun. The server performs these checks as simple data operations on the text string and on derived tokens. The output of this step is a validation result flag and, when validation is successful, an updated request record with status changed to “validated.” If validation fails, the server generates an error status and a message for return to the terminal.

### Step 5

The server generates a prompt sentence based on the situation information. The input of this step is the validated situation text and a stored prompt template. The server loads the template from the storage device, substitutes placeholders with specific instructions and parameter values, and appends the situation text. For example, the server generates a prompt sentence such as:

“You are a corporate compliance analysis engine. Analyze the following workplace situation. Evaluate whether the situation is likely to involve a compliance violation. Consider at least data protection, information security, anti-bribery, harassment, and conflict of interest. Provide your answer with the following fields: risk_score (a real number between 0.0 and 1.0), risk_level (one of “low”, “medium”, “high”), reasons (a list of brief textual explanations), policy_areas (a list of applicable policy areas), and recommendations (a list of concrete next actions for the employee). Situation: [user situation text]”

The server replaces “[user situation text]” with the actual situation description. The data processing here is string concatenation and parameter substitution. The output of this step is a complete prompt sentence ready for use as input to a generative AI model.

### Step 6

The server constructs input data for the generative AI model. The input of this step is the prompt sentence generated in Step 5 and configuration parameters such as model name, temperature, and maximum tokens. The server packs these elements into a request payload compatible with the external processing device, for example, a structured object including a “prompt” field and parameter fields. The server may also generate a correlation identifier to track the model invocation. The data processing includes combining multiple fields into a single structured payload and encoding it for transmission. The output of this step is a generative-AI-request payload stored in memory and ready to be sent over the network.

### Step 7

The server transmits the generative AI model request to an external processing device. The input of this step is the request payload generated in Step 6. The server uses an HTTP client component to serialize the payload, open a secure connection to the external processing device, and send the payload as the body of an HTTP request. The server also sets headers such as authentication tokens and content type. The data operations include encryption at the transport layer and buffering of the outgoing bytes. The output of this step is a transmitted request that arrives at the external processing device hosting the generative AI model.

### Step 8

The server receives response data from the generative AI model. The input of this step is the network response from the external processing device, containing text generated by the generative AI model. The server reads the response body, decodes it from bytes to a text representation, and temporarily stores it in memory. The data processing includes network buffer management, decoding of character encoding (such as UTF-8), and mapping the response text into an internal response object. The output of this step is a raw model response text string accessible to subsequent parsing routines.

### Step 9

The server parses and validates structured information from the model response. The input of this step is the model response text string. The server applies a parsing algorithm that locates and extracts values for fields such as risk_score, risk_level, reasons, policy_areas, and recommendations. The server may use pattern matching or a structured parser to convert the text into an internal representation such as a record with typed fields. The server validates that risk_score is numeric and in the range 0.0 to 1.0, that risk_level is one of a predefined set of categories, and that reasons, policy_areas, and recommendations are lists of strings. The data operations include numerical conversion, type checking, and conditional branching based on validation results. The output of this step is a validated evaluation object containing the extracted risk index, risk category, reason information, policy categories, and recommended action information.

### Step 10

The server evaluates the risk index against threshold conditions. The input of this step is the validated evaluation object from Step 9 and stored threshold values for risk indices. The server compares the numeric risk_score with threshold values such as low_threshold and high_threshold using arithmetic and comparison operations. Based on the comparison results, the server may confirm or adjust the risk_level field. The server also computes internal flags indicating whether the situation is low, medium, or high risk for subsequent processing. The output of this step is an updated evaluation object with consistent risk index and risk category, and additional internal flags indicating risk status.

### Step 11

The server retrieves related regulation information. The input of this step is the set of policy_areas from the evaluation object. The server issues queries to a regulation information storage structure, such as a database table indexed by policy_area. The server searches for records whose policy_area field matches or is related to the values extracted from the model response. The data operations include index lookups, filtering, and retrieval of fields such as policy_id, article_number, and summary. The output of this step is a collection of regulation records relevant to the identified policy areas.

### Step 12

The server generates evaluation result data by combining model response and regulation information. The input of this step is the evaluation object from Step 10 and the regulation records from Step 11. The server constructs a new structured object that embeds the risk index, risk category, reasons, policy areas, recommendations, and associated regulation references. The server attaches identifiers and brief summaries of the relevant regulations. The data processing involves merging two sets of structured data, mapping field names, and removing redundant entries. The output of this step is evaluation result data representing a complete compliance assessment enriched with regulation information.

### Step 13

The server generates a feature quantity for the situation information. The input of this step is the original situation text retrieved from storage. The server normalizes the text by converting characters to a standard case, removing extra whitespace, and optionally removing stop words. The server then applies an embedding function that maps the text to a numeric vector of a fixed dimension. This embedding function may be implemented as a separate model or as a call to a feature extraction service. The data operations include tokenization of the text, indexing into embedding tables, matrix multiplications, and application of non-linear activation functions to obtain the final vector. The output of this step is a high-dimensional feature vector representing the semantic content of the situation information.

### Step 14

The server retrieves feature quantities of past cases and calculates similarity. The input of this step is the feature vector generated in Step 13 and a collection of stored feature vectors for past cases in a case information storage device. The server loads or streams subsets of stored vectors and computes similarity scores, such as cosine similarity, between the current vector and each past case vector. The data processing includes dot products, norm calculations, and ranking by similarity value. The server filters the cases whose similarity score exceeds a predefined threshold or selects the top-N highest-scoring cases. The output of this step is a list of selected past case identifiers and their similarity scores.

### Step 15

The server retrieves summary information and outcome information for the selected past cases. The input of this step is the list of selected past case identifiers. The server queries the case information storage device to obtain, for each identifier, fields such as a textual summary, a description of the confirmed or non-confirmed violation, and recorded actions or sanctions. The data operations involve index lookups and structured data retrieval. The output of this step is a set of past case records including summaries and outcomes relevant to the current situation.

### Step 16

The server generates extended evaluation result data by adding past case information. The input of this step is the evaluation result data from Step 12 and the past case records from Step 15. The server augments the evaluation result data with a dedicated section for similar past cases, including the summaries, outcome descriptions, and similarity scores. The server may also generate derived fields indicating the most representative past case or common patterns among the retrieved cases. The data processing includes appending arrays, computing aggregate statistics, and ensuring that identifiers and references are consistently formatted. The output of this step is extended evaluation result data that links the current evaluation with concrete historical examples.

### Step 17

The server converts the extended evaluation result data into user interface output data. The input of this step is the extended evaluation result data object. The server applies a presentation mapping that converts internal field names into human-readable labels, assigns visualization attributes such as colors and icons based on risk levels, and structures the information into sections suitable for display, such as “Risk Overview,” “Reasons,” “Relevant Policies,” and “Similar Past Cases.” The data operations include formatting numbers (for example, rounding the risk_score), sorting lists, and generating layout descriptors. The output of this step is a user interface output structure that can be directly rendered by the terminal.

### Step 18

The server transmits the user interface output data to the terminal. The input of this step is the user interface output structure stored in the server's memory. The server serializes this structure into a compact representation, attaches it to an HTTP response, and sends the response to the terminal over the communication line. The server may compress the data to reduce bandwidth usage and set headers indicating content type and encoding. The output of this step is a network response containing the formatted evaluation information.

### Step 19

The terminal receives and displays the evaluation result. The input of this step is the network response from the server containing the user interface output data. The terminal parses the received structure, maps it to visual components on the display, and updates the user interface. The terminal displays the risk index and risk category using, for example, a numeric indicator and a color-coded label, shows the reasons and recommended actions as bullet-point lists, and presents links or expandable sections for regulation references and similar past cases. The data operations on the terminal include parsing, layout calculation, and rendering. The output of this step is a fully rendered evaluation screen that the user can view and interact with.

### Step 20

The user reviews the displayed information and may optionally request further processing. The input of this step is the visual presentation on the terminal's display. The user reads the risk index, the reasons, the referenced regulations, and the past case examples. Based on this information, the user may decide to initiate additional interactions, such as requesting a more detailed explanation, asking for alternative recommendations, or submitting feedback. When the user triggers such actions through the terminal's controls, the terminal generates new requests to the server. The output of this step is either a concluded evaluation session or additional user-initiated input that can serve as the starting point for a new processing cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In organizational environments, computer-implemented compliance support systems are increasingly used to assist users in assessing whether particular business situations may constitute policy or regulatory violations. However, conventional systems suffer from several technical limitations that reduce the reliability, efficiency, and auditability of automated compliance assessment.

First, many existing systems rely on rule-based engines or simple keyword matching to evaluate user-submitted descriptions. These approaches operate on unstructured text without generating rich intermediate representations, and therefore fail to capture the contextual nuances of user inputs. As a result, such systems often produce inaccurate or inconsistent risk assessments, which undermines trust in the system and requires substantial manual review.

Second, even when generative AI models are employed, conventional integrations typically submit only the raw user text as a prompt, without incorporating structured information derived from natural language processing, without linking to internal regulation data stores, and without constraining the output format. This leads to responses that are verbose, incomplete, or poorly structured, and which are difficult for downstream software components to parse, normalize, and store in a machine-usable form. Consequently, the overall system cannot reliably orchestrate automated workflows such as conditional administrator notifications or continuous model improvement.

Third, typical systems do not maintain a tightly coupled feedback loop between user interactions, administrator decisions, and the underlying machine learning models. In many implementations, labeled case data and final human decisions are not systematically captured and reused to update the internal risk determination models. This prevents the system from improving over time as new types of violations, domain-specific phrasing, and organization-specific policies emerge, thereby limiting scalability and adaptability.

Fourth, known architectures do not integrate multi-stage processing-natural language preprocessing, regulation retrieval, internal machine learning inference, and generative AI inference-into a cohesive, structured pipeline on the server side. As a result, conventional systems exhibit technical shortcomings such as redundant processing, inconsistent risk scoring between components, and difficulty in correlating an AI model's explanation with the regulations that actually apply to the user's situation. These shortcomings degrade the overall computing performance in terms of accuracy, latency, and resource utilization, and impose a heavy manual burden on administrators who must interpret and reconcile disparate outputs.

Accordingly, there is a need for an improved computer-implemented compliance assessment system that (i) converts user text into structured representations using natural language processing, (ii) automatically aligns such representations with stored regulation information and past case data, (iii) generates prompt sentences for a generative AI model that explicitly encode relevant rules, preliminary machine learning risk estimations, and a structured output specification, and (iv) captures and reuses both AI outputs and administrator decisions to continuously retrain and update an internal compliance risk determination model. Such a system should provide technically improved processing by producing machine-parseable, consistent, and auditable risk evaluations, thereby enhancing the overall operation of the computer-based compliance support environment.

The specific processing by the specific processing unit 290 of the data processing device 12 in Application Example 1 is realized by the following means.

The present invention provides a server comprising a processor and a memory storing instructions that, when executed by the processor, cause the processor to receive, from a terminal operated by a user, text data representing a situation encountered in business operations; apply a natural language processing algorithm to the text data to generate structured information at a word level and a phrase level and to extract words and phrases related to compliance; search, based on the extracted words and phrases, regulation information and past case information stored in a regulation information storage device, and acquire regulation information and case information related to the text data; generate, based on the structured information and the acquired regulation information and case information, a prompt sentence including a question regarding a possibility of a compliance violation and an output format, and input the prompt sentence to a generative AI model; analyze response data output from the generative AI model and generate an evaluation result including risk level information, violation possibility information, and recommended action information; present the evaluation result to the user and, when the risk level information or the violation possibility information satisfies a predetermined condition, transmit notification information to an administrator notification device; and store the text data, the structured information, the regulation information, the response data, and the evaluation result as case data in a storage device, learn or update a compliance risk determination machine learning model based on the case data and final decision information provided by an administrator, calculate a risk estimation value for the text data using the updated machine learning model, and integrate the risk estimation value with the evaluation result. This enables the computing system to perform technically improved compliance assessment by producing structured, machine-parseable, and context-aware risk evaluations that combine deterministic regulation retrieval, internal machine learning inference, and generative AI reasoning, while continuously enhancing model accuracy and system behavior through feedback from accumulated case data and administrator decisions.

The term “terminal” refers to an electronic device operated by a user, such as a general-purpose computing device or a portable communication device, that is configured to transmit text data to the server and to receive and display evaluation results.

The term “text data” refers to character-based information input by a user, including a natural language description of a situation encountered in business operations, that is processed by the server for compliance assessment.

The term “natural language processing algorithm” refers to a software-implemented procedure that analyzes and transforms natural language text into structured representations, including operations such as tokenization, part-of-speech tagging, phrase extraction, and entity recognition.

The term “structured information” refers to data derived from text data by the natural language processing algorithm, including word-level and phrase-level annotations, extracted terms, and categorized entities, that can be processed by subsequent computational components.

The term “word level” refers to a granularity of analysis in which the text data is segmented into individual lexical units, and each lexical unit may be annotated with attributes such as part of speech or lemma.

The term “phrase level” refers to a granularity of analysis in which the text data is segmented into groups of words forming syntactic or semantic units, such as noun phrases or verb phrases, that provide contextual meaning.

The term “regulation information” refers to digital representations of organizational rules, policies, guidelines, and constraints stored in one or more data storage devices, which are applicable to the assessment of compliance-related situations.

The term “past case information” refers to digital records of previously processed situations, evaluations, and outcomes, including historical examples of compliant and non-compliant behavior, that are stored for reference and model training.

The term “regulation information storage device” refers to a hardware-based or virtual data storage resource, such as a database system or data repository, that stores regulation information and past case information in a form retrievable by the server.

The term “prompt sentence” refers to a machine-readable string of text generated by the processor, including instructions, contextual information, and an output specification, that is provided as input to a generative AI model to obtain an evaluation or other response.

The term “generative AI model” refers to a machine learning model configured to generate text-based outputs in response to provided prompts, based on parameters trained on large-scale data, and capable of producing explanations, evaluations, or recommendations.

The term “response data” refers to one or more pieces of information output by the generative AI model in response to a prompt sentence, including textual content that can be analyzed by the processor to derive an evaluation result.

The term “evaluation result” refers to data generated by the processor based on analysis of the response data, including structured elements such as risk level information, violation possibility information, and recommended action information.

The term “risk level information” refers to data indicating a degree or category of risk associated with a situation, such as low, medium, or high, as determined by analysis of the response data and other factors.

The term “violation possibility information” refers to data indicating a likelihood or determination that a situation constitutes or may constitute a violation of regulation information.

The term “recommended action information” refers to data specifying one or more actions suggested to be taken by the user or an administrator in response to the evaluation result, such as escalating the issue or refraining from a certain behavior.

The term “administrator notification device” refers to an electronic device or system used by an administrator, such as a management console, communication terminal, or notification service, that is configured to receive notification information from the server.

The term “case data” refers to a combination of the text data, structured information, regulation information, response data, and evaluation result stored together in a storage device as an instance of a processed situation.

The term “storage device” refers to a hardware-based or virtual memory resource, including semiconductor memory, magnetic storage, or networked storage, used to store case data, models, and other related information.

The term “compliance risk determination machine learning model” refers to a machine learning model configured to estimate a risk value or class for text data with respect to compliance, based on features derived from past labeled cases and associated regulation information.

The term “final decision information” refers to data provided by an administrator that indicates a human-confirmed outcome for a case, including a classification as a violation or non-violation and any associated annotations.

The term “risk estimation value” refers to a numerical or categorical value output by the compliance risk determination machine learning model that represents an estimated risk associated with the text data.

The term “integrate the risk estimation value with the evaluation result” refers to a process in which the processor combines the risk estimation value with elements of the evaluation result, such as the risk level information and violation possibility information, to produce a unified or adjusted assessment.

The term “summary information of organizational regulations” refers to a condensed representation of relevant portions of regulation information, generated or selected by the processor, that is included in a prompt sentence to provide context to the generative AI model.

The term “output format” refers to a predefined or specified structure for the response data, including fields or sections such as risk level information, violation possibility information, reasoning information, and recommended action information, that guides how the generative AI model should present its output.

The term “reasoning information” refers to explanatory data included in or derived from the response data, indicating logical grounds or justifications for an evaluation of compliance risk or violation possibility.

The term “structured output format” refers to a machine-readable specification of the organization of the response data, such as a key-value structure, list, or schema, that allows the processor to parse and interpret the response data in a deterministic manner.

In one embodiment, a server implements the claimed system as a network-connected computing apparatus that cooperates with one or more terminals operated by users and administrators. The server includes a processor, a main memory, a non-volatile storage device, and a network interface. The server runs an operating system such as a general-purpose server operating system, and executes application software implemented, for example, in a high-level programming language. The terminal includes a processor, a display device, an input device, a memory, and a communication interface, and runs a client application such as a web browser or a dedicated application.

The server stores, in the non-volatile storage device, regulation information, past case information, a compliance risk determination machine learning model, and program modules that implement natural language processing, prompt sentence generation, generative AI model communication, evaluation result generation, and model training. The server represents each case as a data record including fields for raw text data, structured information, regulation identifiers, model outputs, and final decision information, and stores these records in a relational database management system, for example a general-purpose relational database engine.

The server uses a natural language processing algorithm implemented by a natural language processing library such as a general-purpose natural language processing toolkit. The server loads, in memory, a language model that provides tokenization, part-of-speech tagging, phrase extraction, and named entity recognition. The server applies the model to the text data received from the terminal to generate structured information. The structured information includes, for each token, attributes such as token text, part-of-speech tag, lemma, and dependency relation, and includes, for each phrase, attributes such as phrase span and phrase type. The server stores this structured information in database tables linked to a case identifier. Because the server converts free-form text into a consistent, indexed representation, subsequent queries on regulation information and case similarity are executed more efficiently, reducing database scan time and improving latency.

The server maintains the regulation information and the past case information in multiple tables. In one configuration, the server stores regulation information in a table that includes fields for a regulation identifier, a category, and a regulation text. The server stores past case information in a table that includes fields for a case identifier, a summary of the situation, labels such as violation or non-violation, and associated regulation identifiers. The server constructs an inverted index or a vector index over these texts. The server uses the structured information derived from the user's text to generate search queries and computes similarity scores between the extracted terms and stored regulation entries. The server retrieves candidate regulations and past cases that exceed a similarity threshold. Because the server uses structured features and indexed search instead of naive keyword search, the server reduces the number of retrieved irrelevant records, thereby reducing I/O operations and CPU time required for subsequent processing.

The server implements the compliance risk determination machine learning model as a neural network classifier, for example a multi-layer feedforward neural network or a transformer-based encoder. In one embodiment, the server uses a neural network with an input layer corresponding to a fixed-length vector representation of the text data, one or more hidden layers with non-linear activation functions such as rectified linear units, and an output layer that produces a probability distribution over risk classes such as compliant, suspicious, or likely violation. The server generates input features for this model by computing text embeddings, for example using word vectors or sentence embeddings derived from pretrained language models, combined with one-hot encodings or numerical encodings of regulation categories and entities recognized in the structured information. The server normalizes and concatenates these features into a numeric vector and supplies the vector to the neural network.

The server trains or updates the machine learning model using supervised learning. The server selects training data from stored case data records, including the structured information and the final decision information entered by an administrator. The server defines a loss function, for example a cross-entropy loss between the predicted class distribution and the true class labels, and uses an optimization algorithm such as stochastic gradient descent or an adaptive gradient method to update the network weights. During training, the server applies techniques such as mini-batch training, dropout, and data augmentation. For data augmentation, the server may randomly mask non-critical tokens or slightly perturb phrase order while maintaining semantic consistency, thereby improving robustness to input variation. Because the server continuously retrains the model using newly labeled data, the server improves prediction accuracy over time and reduces error rates in risk estimation.

The server also communicates with a generative AI model provided by an external or internal generative AI service. The generative AI model is implemented as a large language model, for example a transformer-based network trained on large-scale text data, which generates text given a prompt sentence. The server does not rely on opaque behavior but constrains the model output via explicit prompt engineering and structured output specifications. The server stores configuration parameters such as model identifier, temperature, maximum token count, and stop conditions.

The server generates a prompt sentence for the generative AI model by composing several elements: a role definition, summary information of relevant organizational regulations, a representation of the user's situation, and an explicit instruction regarding the output format. The server produces the summary information by either selecting and concatenating relevant portions of regulation texts or by applying a summarization function to the retrieved regulations; the server may implement this summarization with rule-based text compression or with a smaller language model. The server then constructs the prompt sentence as a single text string.

In one concrete example, when the user enters text data such as “I was told to export all customer phone numbers and upload them to a third-party marketing tool that is not approved by our IT department,” the server derives entities such as “customer phone numbers,” “third-party marketing tool,” and “IT department,” identifies them as personal data and unapproved system channels, and retrieves regulation information stating that personal data must only be processed using approved systems and that third-party tools require prior approval. The server then generates a prompt sentence such as:

“You are a corporate compliance and data protection officer.

### Internal Rules Summary

Personal data, including phone numbers, must only be processed using information technology systems approved by the organization.
Transfers of customer personal data to external tools require prior approval by the designated data protection officer and a valid data processing agreement.

### Employee Situation (Anonymized)

‘I was told to export all customer phone numbers and upload them to a third-party marketing tool that is not approved by our information technology department.’

### Task

As a compliance advisor, assess this situation.

Output your answer with the following items:
risk level: one of ‘low’, ‘medium’, or ‘high’;
violation assessment: ‘yes’ or ‘no’;
reasoning: a short explanation referencing the internal rules;
recommended action: clear next steps for the employee.”

The server transmits this prompt sentence to the generative AI model using a network interface via a secure protocol. The server receives the generated text, which is expected to follow the specified output items. The server parses the returned text using pattern matching or by requiring clearly labeled sections (for example, lines beginning with “risk level:”, “violation assessment:”, “reasoning:”, and “recommended action:”). The server converts these sections into structured data fields and stores them in the database as part of the evaluation result. By enforcing an explicit output schema in the prompt sentence and by post-processing the response according to this schema, the server transforms the generative output into deterministic, machine-parseable data. This structured integration reduces parsing errors and prevents inconsistencies in downstream risk processing.

The server combines the outputs of the compliance risk determination machine learning model and the generative AI model by applying a predefined aggregation rule. For example, the server can map the generative AI model's risk level to numeric scores, average them or apply weights with the risk estimation value from the internal machine learning model, and then select a final risk category based on thresholds. This aggregation is implemented as explicit arithmetic operations and comparison operations executed by the processor. Because the server uses two different models with different training objectives—one optimized for structured numeric classification and one optimized for explanatory reasoning—the system obtains both high predictive accuracy and high interpretability. The combination helps reduce false positives and false negatives compared to using either model alone.

The server presents the evaluation result to the user via the terminal. The terminal receives structured risk information and explanation data from the server and renders them on a graphical user interface. The terminal may display color-coded risk indicators and textual explanations. Because the server has already filtered and structured the information, the terminal does not require heavy local computation, which reduces client-side processing load and network bandwidth usage.

The server also uses the evaluation result to determine whether to generate a notification to an administrator. The server compares the risk level information and violation possibility information against predetermined thresholds stored in configuration tables. If a condition is met, the server sends notification information to an administrator notification device, such as an administrative dashboard or a messaging service endpoint. The notification includes identifiers and summaries that allow the administrator to access full case details through a secure interface. The administrator terminal then enables the administrator to review the case, provide final decision information, and record any remediation actions. The server stores this final decision information in association with the case data, and subsequently uses it as ground-truth labels in the next training cycle of the machine learning model.

The server improves computer technology in several ways. First, by generating and storing structured information from unstructured text using specific natural language processing operations, the server enables efficient indexed queries and vector similarity searches, thereby reducing computation time and memory usage during regulation retrieval and case matching. Second, by constraining generative AI output via carefully designed prompt sentences that include explicit output item definitions, the server ensures that generative responses are machine-parseable and consistent, decreasing the need for heuristic parsing and reducing processing errors. Third, by integrating a continuously updated compliance risk determination machine learning model with the generative AI model, the server implements a non-conventional, multi-model architecture that yields higher accuracy and lower variance in risk assessment than traditional rule-based or single-model systems. Fourth, by capturing administrator feedback as final decision information and reusing it to retrain the neural network, the server establishes a feedback loop that systematically improves the underlying models, leading to measurable reductions in misclassification rates over time.

The server implements learning and inference using explicit algorithms. During training, the server initializes model weights, executes forward propagation to compute outputs for each training example, calculates the loss via a loss function (for example, cross-entropy), and propagates gradients backward through the network using backpropagation. The server updates each weight according to an optimization rule, such as subtracting a learning-rate-scaled gradient. The server repeats this process over multiple epochs, monitors metrics such as validation accuracy and loss, and stores the best-performing model version in the storage device. During inference, the server loads the trained model parameters into memory, executes forward propagation on incoming feature vectors, and obtains risk probability outputs. These operations are implemented with tensor-based linear algebra libraries, enabling hardware acceleration and efficient use of processor cache and memory.

The server thereby implements a specific, non-abstract data flow: from raw text data, through natural language feature extraction, through regulation and case retrieval, through numeric feature generation, through neural network inference, through prompt sentence construction, through generative AI interaction, and finally through structured result aggregation and storage. This structured pipeline contrasts with a mere automation of human judgment, because the server manipulates data structures, indexes, and model parameters in ways that are not directly performed by human operators. The server uses vector spaces, embedding representations, and probabilistic outputs, and enforces structured communication between models, resulting in technical improvements such as lower end-to-end latency for complex compliance assessments, increased throughput in handling many concurrent cases, and reduced memory footprint through feature reuse and shared model components.

In alternative embodiments, the server may use different neural network architectures, such as convolutional neural networks configured for text classification or recurrent neural networks with attention mechanisms. The server may also use different natural language processing toolkits or custom tokenizers adapted to specific languages or domain-specific vocabularies. The generative AI model may be hosted locally on the same server or deployed on a separate computing system connected via a private network. The prompt sentence generation logic may include additional control tokens or instruction patterns to further constrain the generative AI behavior. The aggregation of model outputs may use more complex fusion functions, such as logistic regression on the internal model scores and the generative AI-derived scores, or ensemble voting strategies.

In other variations, the server may perform partial computation on the terminal, for example executing lightweight tokenization and preliminary classification locally, and transmitting only compressed feature representations to the server. This reduces network traffic and protects privacy by avoiding transmission of certain raw terms. The server may additionally compress case data and model parameters using standard compression algorithms to reduce storage requirements and improve I/O performance.

Through these configurations and variations, the server, the terminal, and the user cooperate in a computing environment in which text data, structured information, model outputs, and administrator decisions are processed as defined data structures through a defined pipeline of algorithms. Because this architecture improves the speed, accuracy, and resource efficiency of compliance risk evaluation processing on a computing system, while enabling consistent and auditable interaction with a generative AI model via structured prompt sentences, the embodiments provide a concrete technological implementation that goes beyond an abstract idea or a generic automation of human tasks.

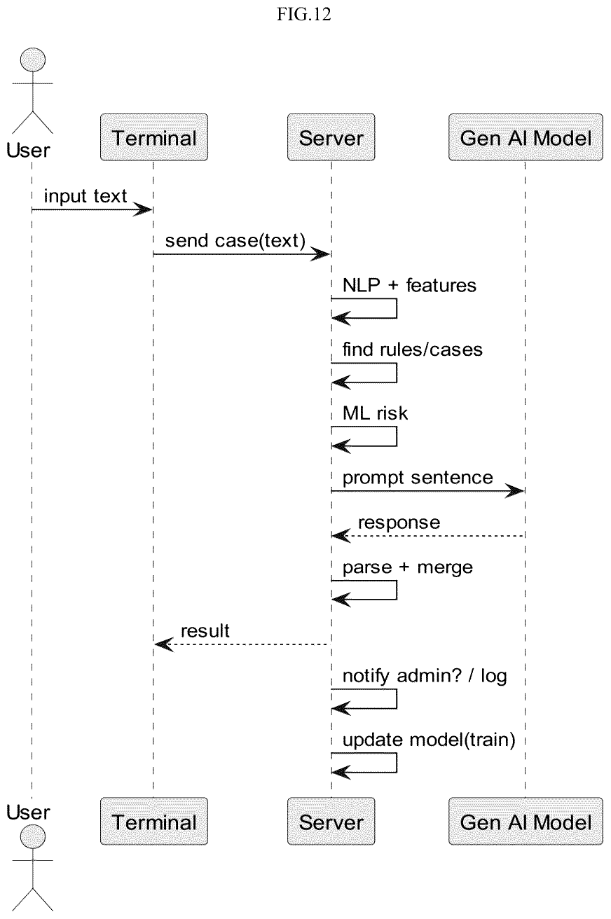

The following describes the processing flow using FIG. 12.

### Step 1

The user enters situation text on the terminal.

The terminal displays an input screen and receives, as input, text data describing a situation encountered in business operations. The terminal validates that the input text is not empty and is within an allowed length range, and associates the text with user identification data and a timestamp. The terminal outputs a structured request payload including the text data, user identification data, and metadata, and transmits this payload to the server via a secure communication protocol.

### Step 2

The server receives and stores the raw request.

The server receives, as input, the request payload from the terminal. The server parses the payload to extract the text data, user identification data, and metadata. The server writes a log record including a request identifier, user identification data, text length, and timestamp to a logging storage. The server also inserts a new case record into a database table, storing the raw text data and metadata. The server outputs a case identifier corresponding to the stored record.

### Step 3

The server performs natural language processing on the text data.

The server receives, as input, the case identifier and the associated text data. The server loads a natural language processing model and applies tokenization, part-of-speech tagging, phrase extraction, and named entity recognition to the text. The server converts the text into structured information, including token-level annotations and phrase-level units, and extracts candidate compliance-related words and phrases such as entities for personal data, organizations, and communication channels. The server stores the structured information and extracted terms in database tables linked to the case identifier, and outputs a set of structured features representing the text.

### Step 4

The server retrieves relevant regulation information and past case information.

The server receives, as input, the structured features including extracted words and phrases for the case identifier. The server uses these features to construct search queries and similarity vectors, and executes queries against a regulation information storage device and a past case storage device. The server computes similarity scores between the extracted terms and stored regulation texts and case summaries, filters results based on thresholds, and selects a subset of relevant regulations and past cases. The server outputs regulation identifiers, regulation text excerpts, past case identifiers, and summaries associated with the case identifier.

### Step 5

The server generates numeric feature vectors for risk estimation.

The server receives, as input, the structured features, the retrieved regulation information, and the past case information. The server converts the structured textual features into numeric representations, for example by computing embeddings for tokens and phrases and by encoding recognized entities and regulation categories as numeric indices. The server concatenates and normalizes these values to form a fixed-length feature vector representing the case. The server stores the feature vector in association with the case identifier and outputs the feature vector as input for a compliance risk determination machine learning model.

### Step 6

The server computes an internal risk estimation using a machine learning model.

The server receives, as input, the feature vector for the case. The server loads a trained neural network model from storage into memory and performs forward propagation: the server multiplies the input vector by weight matrices, adds bias vectors, applies activation functions in intermediate layers, and computes output values at the final layer. The server interprets the output values as class probabilities for categories such as compliant, suspicious, and likely violation. The server selects the highest-probability class as a predicted label and may also compute a scalar risk estimation value. The server stores the predicted label and risk estimation value in the database and outputs these values linked to the case identifier.

### Step 7

The server constructs a prompt sentence for the generative AI model.

The server receives, as input, the case identifier, the original text data, the structured features, the retrieved regulation texts, and the internal risk estimation value. The server selects or generates summary information for the relevant regulations and anonymizes or reformats the user's situation text. The server composes a prompt sentence by concatenating a role instruction for a compliance advisor, the regulation summaries, the anonymized situation text, and an explicit instruction describing an output format including risk level, violation assessment, reasoning, and recommended action. The server may truncate or summarize excessively long regulation texts to meet model input limits. The server stores the constructed prompt sentence as part of the case record and outputs the prompt sentence as input to the generative AI model.

### Step 8

The server sends the prompt sentence to the generative AI model and receives a response.

The server receives, as input, the prompt sentence and configuration parameters such as model identifier, temperature, and maximum output length. The server constructs an API request payload including the prompt sentence and parameters, and transmits this payload to a generative AI model endpoint over a secure network connection. The generative AI model executes its internal text generation algorithm and returns response data as generated text. The server receives the response data, verifies that it conforms to expected size constraints, and associates it with the case identifier. The server outputs the raw response text for further analysis.

### Step 9

The server parses and structures the generative AI response data.

The server receives, as input, the raw response text from the generative AI model. The server analyzes the text by locating sections identified by keywords such as “risk level:”, “violation assessment:”, “reasoning:”, and “recommended action:”. The server extracts the corresponding substrings and trims whitespace and delimiters. The server converts the extracted substrings into structured fields, for example mapping the risk level string to an internal enumeration and mapping the violation assessment string to a Boolean flag. The server stores these structured fields in the evaluation result tables associated with the case identifier and outputs an intermediate evaluation result including the generative AI-derived risk level, violation flag, reasoning text, and recommended action text.

### Step 10

The server integrates the internal risk estimation with the generative AI evaluation result.

The server receives, as input, the internal risk estimation value and label from the machine learning model, and the structured evaluation result from the generative AI response. The server converts the generative AI risk level into a numeric score and applies an aggregation rule that may combine the internal risk estimation value and the generative AI score, for example by computing a weighted sum or by applying threshold-based decision logic. The server determines a final risk category and a final violation possibility value, and may adjust the explanation and recommended action according to predefined rules. The server stores the integrated final evaluation result in the database and outputs the final risk level, violation possibility, explanation, and recommended action.

### Step 11

The server returns the final evaluation result to the terminal.

The server receives, as input, the final evaluation result linked to the case identifier. The server formats this result as a response payload including fields such as risk level, violation indication, explanation text, and recommended action text. The server transmits the response payload to the terminal over the network. The terminal receives the payload, parses the fields, and updates the user interface to display a risk indicator, an explanation, and recommended next steps. The terminal outputs a human-readable presentation of the evaluation result to the user.

### Step 12

The server determines whether to notify an administrator and, if necessary, sends a notification.

The server receives, as input, the final risk level and violation possibility associated with the case identifier. The server compares these values against notification criteria stored in configuration data. If the criteria are satisfied, the server generates a notification payload including the case identifier, a summary of the situation, key regulations involved, and the final evaluation result. The server transmits the notification payload to an administrator notification device via an email system, messaging system, or administrative dashboard interface. The server records the notification event in a log table and outputs a notification status linked to the case.

### Step 13

The administrator reviews the case and provides final decision information via an administrator terminal.

The administrator terminal sends, as input to the server, a request to view case details identified by the case identifier. The server retrieves the raw text data, structured features, regulation information, internal model outputs, generative AI outputs, and final evaluation result from the database, and outputs these data to the administrator terminal. The administrator terminal displays this information, and the administrator inputs a final decision such as “violation” or “non-violation,” together with optional comments and selected remediation actions. The administrator terminal transmits this final decision information to the server. The server receives the final decision information and stores it in association with the case identifier as final decision data.

### Step 14

The server updates training data and retrains the compliance risk determination machine learning model.

The server receives, as input, accumulated case data records including feature vectors and corresponding final decision information. The server constructs a training dataset by pairing each feature vector with a class label derived from the final decision data. The server initializes or loads a neural network model and performs multiple training iterations: in each iteration, the server feeds batches of feature vectors through the network, computes output probabilities, evaluates a loss function such as cross-entropy between predictions and labels, computes gradients via backpropagation, and updates model weights according to an optimization algorithm. The server monitors performance metrics on validation data and selects a model snapshot that satisfies predetermined accuracy criteria. The server stores the updated model parameters in the storage device as a new version of the compliance risk determination machine learning model and outputs an updated model identifier to be used for subsequent inferences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented compliance support systems largely rely on static rule engines or manually crafted decision trees to evaluate whether a user's described behavior may constitute a compliance violation. In such systems, the processor typically matches user input text against predefined keywords and fixed templates and then outputs a coarse rule hit or no-hit result. This architecture suffers from several technical limitations.

First, the processor in such systems is not configured to perform rich semantic analysis of unstructured natural language descriptions provided by users through terminals. As a consequence, the system cannot reliably extract action types, risk factors, and contextual conditions from diverse, ambiguous user inputs. This leads to frequent misclassification or failure to recognize nuanced scenarios, and forces the user to repeatedly reformulate the input. From a computer technology perspective, this results in inefficient utilization of computational resources: the system performs repeated shallow matching operations while still failing to converge to an accurate machine-interpretable representation of the user's situation.

Second, existing systems do not integrate a generative model in a way that structurally improves the internal processing pipeline of the computer. When generative models are used at all, they are often treated as black-box “advice generators” without alignment to internal data structures such as regulation databases. The processor therefore cannot systematically convert a free-form generative output into structured signals-such as risk levels, regulation categories, and actionable recommendations-that can be directly cross-checked against internal regulation data. This disconnect leads to a technically suboptimal architecture in which the generative component and the database component operate in isolation, increasing processing latency and complexity of post-processing, and making it difficult to ensure consistency and traceability of results.

Third, conventional compliance tools generally do not dynamically generate and manage prompt sentences based on structured intermediate representations derived from user input. As a result, the generative model is often invoked with generic or manually written prompts that are not tailored to the specific action type and risk factors identified in a given consultation. This yields non-deterministic, noisy outputs that require additional human intervention or ad hoc filtering logic. From a computing standpoint, such non-optimized prompts lead to unnecessary token processing by the generative model, increased network and processing overhead, and decreased throughput of the overall system.

Fourth, existing systems lack a unified mechanism for the processor to synthesize and return evaluation data that consistently combines: (i) a machine-derivable risk assessment obtained from a generative model, and (ii) precise internal regulation entries retrieved from a structured database. Without this synthesis, the processor cannot automatically generate stable, user-facing evaluation data that includes a clear violation likelihood, linked regulation articles, and recommended measures. This forces additional post-processing or manual review, which degrades the scalability and technical performance of the system.

Accordingly, there is a need for an improved computer-implemented system and processing method in which the processor: (i) automatically transforms unstructured user input into structured action types and risk factors using natural language processing, (ii) generates optimized prompt sentences and prompt data tailored to the extracted structure, (iii) orchestrates interaction with a generative AI model to obtain semantically rich but structurally interpretable response data, and (iv) automatically cross-checks the response data with an internal regulation database to produce consistent, machine-generated evaluation data. Such a system should technically improve the way the computer represents, processes, and integrates natural language compliance consultations, thereby enhancing accuracy, efficiency, and scalability of compliance evaluation as a computer technology.

The specific processing by the specific processing unit 290 of the data processing device 12 in Example 2 is realized by the following means.

The present invention provides a server comprising a processor configured to receive, from a user terminal, input data including natural language information related to compliance; to tokenize the input data by using a natural language processing algorithm and to extract important expressions, action contents, and situation information so as to specify an action type to be evaluated for compliance and a risk factor; to generate prompt data including a prompt sentence that instructs a generative AI model to perform a compliance evaluation based on the specified action type and the specified risk factor and to transmit the prompt data to the generative AI model via a communication interface; to analyze response data obtained from the generative AI model and to extract, from the response data, risk level information and regulation classification information that are machine-interpretable by the processor; to search a regulation database storing internal regulation information based on the action type, the risk factor, and the regulation classification information, and to acquire a regulation candidate corresponding to the input data and content information of the regulation candidate; to generate evaluation data including an evaluation result regarding a possibility of a compliance violation, regulation information corresponding to the evaluation result, and recommended response content, based on the response data and the regulation candidate; and to transmit the evaluation data to the user terminal in a displayable format to be provided via a user interface. This enables the computer system to technically improve the processing of unstructured compliance-related natural language input by automatically converting the input into structured action and risk representations, dynamically constructing optimized prompt sentences for a generative AI model, integrating semantically rich model outputs with structured regulation data, and outputting consistent, machine-generated evaluation data that enhances accuracy, resource efficiency, and scalability of compliance evaluation performed by the server.

The term “user terminal” refers to an information processing device operated by a user, such as a computing device or communication device, that transmits input data to the system and receives evaluation data from the system via a communication network.

The term “input data” refers to electronic data received from a user terminal and including at least natural language information that describes an action, situation, or question related to compliance.

The term “natural language information” refers to character data or symbol data expressed in a human language and describing behavior, circumstances, or intentions in a free-text or speech-derived form.

The term “processor” refers to a hardware computation unit, such as a central processing unit or a processing circuit, configured to execute program instructions for performing the functions of the system.

The term “natural language processing algorithm” refers to a software procedure executed by the processor to perform analysis on natural language information, including at least tokenization and extraction of linguistic features.

The term “tokenize” refers to a process in which the processor divides natural language information into smaller units, such as words, subwords, or symbols, for subsequent analysis.

The term “important expressions” refers to textual segments extracted from the input data that represent key concepts, entities, or terms relevant to compliance evaluation.

The term “action contents” refers to information in the input data that describes a user's planned or performed behavior to be evaluated for compliance.

The term “situation information” refers to contextual information in the input data that supplements the action contents, including conditions, relationships, time, or environment related to the action.

The term “action type” refers to a classification label indicating a category of the action contents, such as procurement behavior, financial transaction, information handling, or relationship management.

The term “risk factor” refers to a condition or attribute extracted from the input data that may increase the likelihood of a compliance violation associated with an action type.

The term “prompt data” refers to electronic data generated by the processor and including at least one prompt sentence configured to be input to a generative AI model.

The term “prompt sentence” refers to a natural language instruction included in the prompt data that defines a task, role, or question to be executed by a generative AI model.

The term “generative AI model” refers to a trained machine learning model, such as a neural network model, configured to generate natural language output in response to an input including a prompt sentence.

The term “response data” refers to electronic data output from a generative AI model in response to the prompt data and including at least natural language content used for compliance evaluation.

The term “risk level information” refers to information derived from the response data that indicates a degree of likelihood or severity of a potential compliance violation.

The term “regulation classification information” refers to information derived from the response data that identifies a category or type of regulation applicable to the action contents.

The term “regulation database” refers to a storage facility, such as a data storage device or database system, that stores internal regulation information including rules, policies, and procedures.

The term “internal regulation information” refers to machine-readable data representing organizational rules, policies, standards, and procedures used to evaluate compliance.

The term “regulation candidate” refers to one or more regulation entries retrieved from the regulation database as being relevant to the input data based on the action type, risk factor, or regulation classification information.

The term “content information of the regulation candidate” refers to information associated with a regulation candidate, including at least text of a rule, a title, a summary, or metadata.

The term “evaluation data” refers to electronic data generated by the processor and including an evaluation result, regulation information, and recommended response content regarding the input data.

The term “evaluation result” refers to information that indicates a conclusion or determination regarding a possibility of a compliance violation based on the response data and the regulation candidate.

The term “regulation information” refers to information representing one or more regulations associated with the evaluation result, including identifiers, titles, and relevant portions of the regulation text.

The term “recommended response content” refers to information that indicates one or more actions, measures, or procedures recommended to the user in view of the evaluation result and the regulation information.

The term “displayable format” refers to a data format, such as a structured text format or markup format, that can be rendered by a user interface of a user terminal for human reading.

The term “user interface” refers to a software or hardware interface, such as a graphical user interface or text-based interface, through which the user terminal presents information to a user and receives operations from the user.

In one embodiment, a server, a terminal, and a user cooperate to realize a computer-implemented compliance evaluation system that uses a generative AI model and a prompt sentence in a technically specific manner.

### A. Overall Configuration

The server includes at least one processor, a main memory, a non-volatile storage device, a network interface, and an interface to a regulation database. The processor is, for example, a general-purpose central processing unit or a multi-core processor. The main memory stores program modules and data structures used to perform compliance evaluation. The non-volatile storage device is, for example, a magnetic disk drive or a solid-state drive, and stores regulation information, prompt generation rules, and logging data. The network interface is, for example, an Ethernet interface or a wireless communication interface, and connects the server to the terminal and to an external generative AI model service via a communication network.

The terminal is, for example, a portable information processing device such as a smartphone, a tablet device, or a personal computer. The terminal includes a processor, a display device, an input device such as a keyboard or a touch panel, and a communication module. The terminal executes a browser program or a dedicated application program to present a user interface for compliance consultation.

The regulation database is implemented as a database system such as a relational database management system. The regulation database stores internal regulation information as structured records, including rule identifiers, titles, full text of rules, categories, risk levels, and references to internal procedures.

The server executes one or more software modules in the main memory, including a communication module, a natural language processing module, a prompt generation module, a generative model interface module, a regulation retrieval module, and an evaluation synthesis module. In one example, the server uses a software platform such as a web application framework implemented in a general-purpose programming language, and uses a natural language processing library such as a tokenization engine and an entity recognition engine.

### B. Data Structures

The server uses an internal data structure to represent a consultation. The consultation includes at least: a consultation identifier, a user identifier, original input text, an action type, one or more risk factors, regulation classification information, response data from the generative AI model, regulation candidates, and evaluation data. The server stores the consultation as a record in a database table.

The server uses a data structure for prompt data. The prompt data includes at least: a role description segment, a task description segment, a situation description segment, and an output format requirement segment. These segments are concatenated to form a prompt sentence that is compatible with the generative AI model. By defining these fields explicitly, the server can automatically adjust the content and length of the prompt sentence, thereby reducing unnecessary token processing and network traffic.

The server uses a regulation record that includes fields for rule category, applicable action types, prohibited risk factors, required procedures, and exception conditions. These fields are used as machine-interpretable features that permit efficient matching between a user scenario and relevant regulations using database queries and vectorized comparisons.

### C. Natural Language Analysis and Feature Extraction

The server uses a natural language processing module to transform unstructured input data into structured information. The server applies a tokenization algorithm that splits the user's natural language information into units such as words or subwords. The server then applies a part-of-speech tagging algorithm and a named entity recognition algorithm to identify action verbs, objects, and contextual entities such as organizations and roles.

The server applies a classification function that maps the extracted words and entities to one or more action types and risk factors. For example, when the input includes a phrase such as “select a supplier without competitive bidding,” the server classifies the action type as “procurement” and identifies a risk factor as “absence of competitive process.” The server may use a pre-trained language representation model as a feature extractor, and may apply a linear classifier or a simple neural classifier to map the feature vectors to discrete action type labels and risk factor labels.

By performing this feature extraction on the server, the system converts free-text into compact structured representations before contacting the generative AI model. This reduces the size of data transmitted to the external model and enables the server to reuse internal structured features for regulation retrieval and logging, thereby improving communication efficiency and data management.

### D. Prompt Generation and Optimization

The server uses the prompt generation module to construct a prompt sentence for the generative AI model. The server combines the action type, risk factors, and context into a structured template. The server generates a role description, such as:

“You are a corporate compliance officer specializing in internal reporting rules and procurement regulations.”

The server generates a task description, such as:

“Provide: (1) a risk level (Low/Medium/High) regarding potential rule violation, (2) the reasoning, and (3) recommended actions for the employee.”

The server generates a situation description based on the structured features, such as:

“Situation: The employee plans to select a supplier without any competitive bidding process and wants to know whether this may violate internal reporting rules and procurement-related compliance policies.”

The server concatenates these segments into a prompt sentence, for example:

“You are a corporate compliance officer specializing in internal reporting rules and procurement regulations.

Provide: (1) a risk level (Low/Medium/High) regarding potential rule violation, (2) the reasoning, and (3) recommended actions for the employee.

Situation: The employee plans to select a supplier without any competitive bidding process and wants to know whether this may violate internal reporting rules and procurement-related compliance policies.”

In another example, the server generates a prompt sentence to obtain a recommended response policy, such as:

“Act as a compliance and expense policy expert.

Situation: An employee went on a business trip that included personal sightseeing days and now wants to claim reimbursement for the entire hotel stay.

Task: Evaluate the compliance risks under typical corporate travel and expense policies. Provide: (1) possible violations, (2) criteria to distinguish business from personal expenses, and (3) recommended reporting and documentation steps.”

By generating the prompt sentence from structured features rather than directly forwarding the raw user text, the server reduces ambiguity in model input and constrains the model's operation to specific tasks and formats. This improves the accuracy and consistency of the model's outputs and reduces the burden on subsequent parsing. The server may maintain multiple prompt templates associated with different action types, and select a template according to the detected domain, thereby technically improving the utilization of the generative AI model.

### E. Generative AI Model and Interface

The server interacts with a generative AI model through the generative model interface module. The generative AI model may be implemented as a transformer-based neural network, trained on a large corpus of text. The model includes multiple layers of self-attention and feedforward units. Each layer processes token embeddings using learned weight matrices. The model is trained, for example, by a next-token prediction objective or a masked language modeling objective. During training, the model adjusts its internal parameters by gradient-based optimization using an error function such as cross-entropy between predicted token distributions and target tokens.

The server uses the prompt sentence as an input sequence to the generative AI model. The server transmits the tokenized prompt sequence via a network interface to a remote inference engine. The inference engine executes the transformer layers on specialized hardware such as graphics processing units and returns generated token sequences as response data.

The server configures parameters of the generation algorithm, such as temperature, maximum number of tokens, and top-k or nucleus sampling thresholds, to control variability and length of the response. By adjusting these parameters based on the complexity of the action type, the server can reduce unnecessary tokens and model computation for simple queries, thus decreasing processing time and network load.

The server does not treat the model as a generic black box, but constrains the input format and expected output structure through prompt engineering and response parsing, which is implemented as a specific data processing logic in the server. This combination of structured input features and constrained output format yields a technical improvement over naive use of generative models, because it enables reliable machine interpretation of the output and efficient database integration.

### F. Response Parsing and Regulation Retrieval

The server receives the response data, which is a natural language text produced by the generative AI model. The server applies a response parsing algorithm to extract risk level information, regulation classification information, and recommended actions from the response text. The server may use pattern recognition, such as identifying lines that start with “Risk level:” or “Recommended actions:”, or may use an additional lightweight classifier to map segments of the response to predefined output fields.

The server then uses the regulation classification information and the previously identified action type and risk factors to query the regulation database. The server constructs search conditions using rule categories and keyword matches in rule text. The server may also compute similarity scores between a vector representation of the user's situation and vector representations of regulations, which are computed offline and stored as regulation embeddings. The server ranks candidate regulations according to similarity and category match, and selects one or more regulation candidates to be associated with the consultation.

For example, when the action type is “procurement” and the risk factor is “absence of competitive bidding,” the server retrieves a rule whose category is “procurement” and whose text includes conditions such as “Employees shall perform competitive bidding when selecting suppliers, except in documented exceptional cases that have prior approval.” The server then associates this regulation with the consultation as a regulation candidate.

### G. Evaluation Synthesis and Technical Effects

The server integrates the structured response data and the regulation candidate data into evaluation data. The evaluation data includes a machine-generated evaluation result, such as “High risk of violation,” a list of applicable regulations with rule identifiers and excerpts, and recommended response content such as “Do not select the supplier without competitive bidding unless there is a documented, approved exception; contact the compliance department; follow the prescribed approval workflow.”

By combining generative outputs with structured regulation records, the server creates a stable and traceable evaluation record. Because the server stores all intermediate structured features and links them to regulations, the system can be audited and reproduced without requiring re-execution of the generative model. This improves data management and reliability.

From a technical perspective, this architecture improves computational efficiency in at least three ways. First, the server reduces the input dimensionality for the generative AI model by pre-classifying the scenario and generating compact, targeted prompt sentences. Second, the server reduces post-processing overhead by enforcing a constrained output format and by using simple pattern-based or classifier-based parsing, instead of arbitrary text interpretation. Third, the server enables efficient database queries by translating natural language context into database-friendly features such as action type and rule category, which can be indexed.

These improvements lead to faster response times, lower network communication volume, and lower computational load on external model infrastructure, while concurrently improving the precision of compliance evaluation.

### H. Additional Embodiments and Variations

The server can employ different types of natural language processing algorithms for feature extraction. In one embodiment, the server uses a rule-based parser for domain-specific phrases. In another embodiment, the server uses a learned sequence labeling model that identifies action spans and context spans in the text. The server may combine these approaches to enhance robustness.

The server can also vary the structure of the prompt sentence depending on the use case. For example, when the user requests a concrete example of a violation, the server uses a prompt sentence such as:

“You are a corporate compliance officer.

Situation: An employee received an expensive dinner invitation from a business partner during ongoing contract negotiations.

Task: Provide one or more concrete examples of situations that would clearly constitute a violation of internal anti-bribery and conflict-of-interest rules in a similar context, and explain why each example is a violation.”

In this embodiment, the server parses the response to identify multiple example situations and links each example to one or more regulations in the regulation database. The server then presents these examples as concrete violation scenarios.

In another variation, the server uses a different generative AI model topology, such as a smaller transformer model deployed locally on the server for privacy-sensitive use cases. In this case, the server loads model parameters from a storage device and executes inference on a local accelerator. The same prompt generation and response parsing logic can be applied, but network latency is reduced because no external call is needed.

The terminal can also be configured in multiple ways. In one embodiment, the terminal executes a browser-based client that communicates with the server via an HTTP-based protocol. In another embodiment, the terminal runs a native application that maintains local caching of recent consultations and pre-fetches frequently used regulation summaries from the server, thereby reducing communication overhead and accelerating user interaction.

### I. Technical Improvement Over Human and Conventional Processing

The described system does not merely automate human review of compliance questions. The server performs processing that would be infeasible or highly inefficient for a human, such as: systematic extraction of structured features from large volumes of text, consistent and repeatable integration of generative outputs with an internal regulation database, and dynamic optimization of prompt sentences to minimize token usage while maintaining sufficient context.

The server uses specific data structures, algorithmic steps, and model parameter controls to achieve lower latency, reduced communication load, and improved accuracy of mapping between real-world behavior descriptions and formalized regulations. Because the server organizes the data flow from natural language input to model prompt to structured response to regulation retrieval in a tightly coupled pipeline, the computer itself is improved as a tool for processing compliance-related natural language data.

In summary, the server, the terminal, and the regulation database cooperate to provide a technical solution that enhances the operation of a computer system by converting unstructured compliance questions into structured, machine-interpretable representations, by using a generative AI model under constrained, optimized prompting conditions, and by synthesizing consistent, regulation-linked evaluation data that can be efficiently stored, retrieved, and displayed to the user.

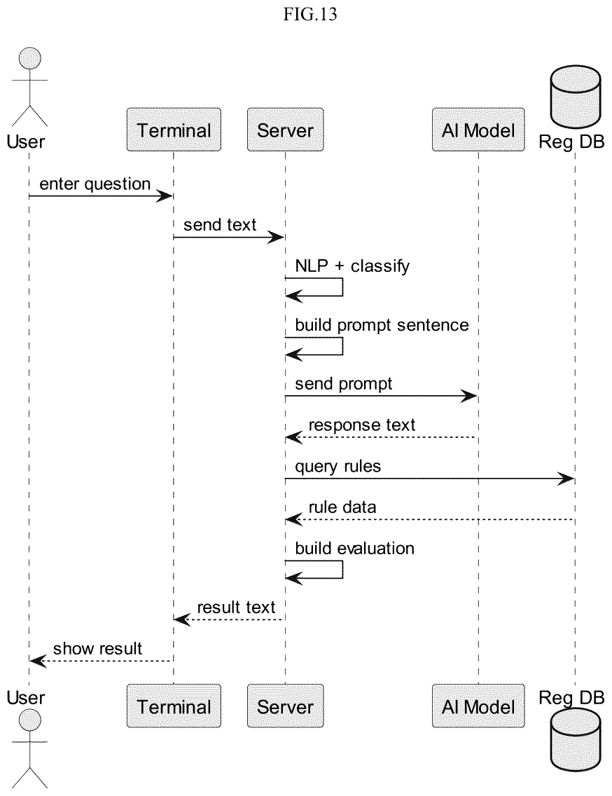

The following describes the processing flow using FIG. 13.

### Step 1

The user operates the terminal to input a compliance-related question as natural language text.

The terminal receives, as input, user-generated text describing an action and its context (for example, “I plan to select a supplier without competitive bidding. Is this against our internal rules?”).

The terminal converts key presses or voice input into a character string, encapsulates the string with a user identifier into a request object, and outputs the request object to the server via a network interface using a communication protocol.

### Step 2

The server receives, as input, the request object from the terminal containing the user identifier and the natural language text.

The server parses the communication packet, extracts the user identifier and the text field, and stores them into a temporary consultation record in a storage device.

The server outputs a structured consultation record that includes at least: a consultation identifier, the user identifier, the original text, and a timestamp.

### Step 3

The server takes, as input, the consultation record including the original text, and executes a natural language processing algorithm.

The server tokenizes the text into tokens, performs part-of-speech tagging, and executes entity recognition to detect action expressions, objects, and contextual entities.

The server aggregates the detected features, applies a classification algorithm to map them to an action type (for example, “procurement”) and one or more risk factors (for example, “no competitive bidding”), and outputs an enriched consultation record that now includes the action type and the risk factors in addition to the original text.

### Step 4

The server takes, as input, the enriched consultation record including the action type, risk factors, and original text, and generates structured prompt data.

The server selects a prompt template associated with the detected action type and inserts the specific risk factors and situation description into the template.

The server concatenates a role description, a task description, and a situation description into a prompt sentence, for example:

“You are a corporate compliance officer specializing in internal reporting rules and procurement regulations.

Provide: (1) a risk level (Low/Medium/High) regarding potential rule violation, (2) the reasoning, and (3) recommended actions for the employee.

Situation: The employee plans to select a supplier without any competitive bidding process and wants to know whether this may violate internal reporting rules and procurement-related compliance policies.”

The server outputs prompt data that includes this prompt sentence and control parameters for the generative AI model.

### Step 5

The server takes, as input, the prompt data including the prompt sentence and model control parameters, and invokes the generative AI model through a model interface.

The server converts the prompt sentence into a sequence of tokens, wraps the tokens into an API request message, and transmits the message to an inference engine that hosts the generative AI model.

The server waits for a response, receives generated token sequences from the inference engine, decodes them into natural language text, and outputs response data that includes the generated text corresponding to the prompt sentence.

### Step 6

The server takes, as input, the response data generated by the generative AI model, and parses the content to extract structured information.

The server scans the response text for predefined labels or patterns (for example, “Risk level:”, “Reasoning:”, “Recommended actions:”) and segments the text into associated fields.

The server processes these segments to normalize the risk level into a discrete value (for example, mapping “high risk” to a “High” code), extracts regulation-related categories or keywords mentioned in the reasoning (for example, “fair competition,” “conflict of interest”), and outputs a response interpretation object that includes the risk level, regulation classification information, and recommended action candidates.

### Step 7

The server takes, as input, the response interpretation object together with the action type and risk factors from the consultation record, and queries the regulation database.

The server constructs a query using the action type, risk factors, and regulation classification information as search keys, executes the query against the regulation database, and retrieves one or more regulation records that satisfy the search conditions.

The server filters and ranks the regulation records according to similarity and category match, and outputs a set of regulation candidates that include rule identifiers, titles, and relevant text excerpts.

### Step 8

The server takes, as input, the regulation candidates and the response interpretation object, and synthesizes evaluation data.

The server compares the risk level and reasoning from the generative AI model with the conditions described in each regulation candidate, determines a final evaluation result regarding the possibility of a compliance violation, and selects the most relevant regulation information.

The server combines the evaluation result, the selected regulation identifiers and excerpts, and the recommended actions into a structured evaluation data object that describes, for example, “Potential violation: High risk,” lists applicable rules, and specifies recommended user actions.

The server outputs the evaluation data object and updates the consultation record to include this evaluation data.

### Step 9

The server takes, as input, the evaluation data object and generates a response message for the terminal.

The server converts the structured fields of the evaluation data into a displayable format, such as a formatted text block that includes headings for “Result,” “Reason,” “Applicable internal rule,” and “Recommended actions.”

The server encapsulates this formatted text into a communication response and outputs the response to the terminal via the network interface.

### Step 10

The terminal receives, as input, the response message containing the formatted evaluation data from the server.

The terminal parses the response, extracts the formatted text, and renders it on the display device within a user interface area dedicated to compliance results.

The terminal outputs the displayed evaluation result to the user, showing, for example, that the planned supplier selection without competitive bidding has a high risk of violating procurement rules, together with specific rule excerpts and recommended next steps.

### Step 11

The user receives, as input, the displayed evaluation result on the terminal screen and interprets the system's guidance.

The user reviews the indicated risk level, reads the applicable regulation excerpts, and considers the recommended actions, such as refusing a particular course of conduct or seeking formal approval.

The user outputs, in the sense of behavior selection, a revised plan or follow-up query, and may input additional information into the terminal to perform another consultation, thereby iteratively refining compliance decisions with the assistance of the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented compliance support systems typically rely on static rule sets, fixed keyword matching, and manually crafted decision trees. Such systems suffer from several technical limitations. First, they cannot robustly interpret diverse natural-language inputs from users, particularly when the inputs contain ambiguous phrasing, implicit intent, or context-specific nuances. Second, these systems usually treat all user inputs uniformly and do not adapt their processing based on user emotion or interaction history, resulting in outputs that may be technically correct yet poorly aligned with the user's state and therefore ineffective in preventing risky actions. Third, conventional systems are generally not architected to systematically integrate responses from generative AI models with structured enterprise rule data and past violation data in a machine-usable and self-improving manner. As a consequence, the system's internal processing pipeline is fragmented: model outputs remain unstructured, are difficult to combine with deterministic rule evaluation, and cannot be reliably reused as training data to improve future performance.

From a computer-technology standpoint, these limitations manifest as inefficient use of computational resources, suboptimal data representations, and an inability to automatically refine internal models based on accumulated interaction logs. For example, naive invocation of a generative AI model for each user query without structured prompt design and response parsing leads to non-deterministic, verbose outputs that must be manually interpreted or discarded; the computing device cannot exploit those outputs as structured signals to update classifiers or to drive real-time user-interface behavior. Furthermore, existing systems do not support low-latency, real-time compliance evaluation for in-progress user inputs (such as unsent chat messages or draft posts) in a way that integrates generative AI reasoning, internal rules, and emotion analysis. This prevents the computing device from providing inline warnings at the time and place where user actions are being formed.

Accordingly, there is a need for an improved computer-implemented system that (i) converts natural-language user inputs into feature representations suitable for joint processing by generative AI models, rule engines, and similarity models; (ii) generates and uses prompt sentences that cause the generative AI model to return structured responses aligned with predefined evaluation schemas; (iii) combines these structured responses with internal rule information and past case information to compute machine-usable violation probabilities and risk levels; (iv) incorporates emotion analysis of the user input to control the content, structure, and tone of outgoing messages; (v) applies the same processing pipeline to partial, unsent user messages in real time to generate inline warnings; and (vi) accumulates all interaction data, decisions, and user actions as training data so that the system's models can be retrained or fine-tuned in a continuous, automated manner. Such an architecture improves the functioning of the underlying computer system by enabling more effective, structured, and adaptive processing of natural-language inputs for compliance evaluation, reducing latency for real-time guidance, and enhancing the system's ability to self-improve over time.

The specific processing by the specific processing unit 290 of the data processing device 12 in Application Example 2 is realized by the following means.

The present invention provides a server comprising a processor and a memory that stores instructions which, when executed by the processor, cause the processor to receive character information from a user terminal and perform preprocessing on the character information to extract feature information; to search, based on the feature information, rule information and case information stored in a storage device, and to acquire rule information and case information that are associated with the character information; to generate, based on the character information and the acquired rule information and case information, a prompt sentence that instructs a generative AI model to perform a compliance evaluation, and to input the prompt sentence to the generative AI model; to analyze response data obtained from the generative AI model, and to determine a possibility of a compliance violation based on the response data, an evaluation criterion, and the rule information and the case information; to perform emotion analysis on the character information to estimate an emotional state of a user; to generate warning information and guidance information by adjusting content and expression of an output message according to the emotional state and a determination result of the possibility of the compliance violation, and to transmit the warning information and the guidance information to the user terminal; and to accumulate, as learning data, the character information, the determination result, the emotional state, and final action information of the user, and to use the learning data for training of the generative AI model or another machine learning model. This enables the computer system to transform unstructured natural-language inputs into structured, multi-source compliance evaluations in a low-latency, adaptive manner, to provide real-time, emotion-aware warnings for both finalized and in-progress user actions, and to continuously improve its internal models and decision quality through automated reuse of accumulated interaction data.

The term “processor” refers to a hardware processing unit, such as a central processing unit, a graphics processing unit, or another arithmetic and logic unit, that executes instructions to perform data processing operations.

The term “memory” refers to a hardware storage device, such as a semiconductor memory, a magnetic storage medium, or an optical storage medium, that stores programs, parameters, models, and data used by the processor.

The term “user terminal” refers to an information processing device operated by a user, such as a personal computer, a portable terminal, a smartphone, a tablet, or a wearable device, that transmits information to and receives information from the server.

The term “character information” refers to data representing text in a natural language, including letters, numerals, symbols, and control characters, which are input by a user through the user terminal.

The term “preprocessing” refers to a series of operations performed on character information to normalize, segment, clean, or otherwise transform the character information into a form suitable for subsequent analysis, such as tokenization, sentence splitting, or noise removal.

The term “feature information” refers to data derived from the character information through preprocessing, including but not limited to tokens, keywords, entities, embeddings, and other representations that characterize the content of the character information.

The term “rule information” refers to data representing constraints, policies, regulations, or guidelines defined within an organization, stored in a storage device, and used as a basis for evaluating compliance of user actions.

The term “case information” refers to data representing past events, including previous compliance violations, near misses, or related incidents, stored in a storage device and used as reference information for similarity assessment or risk evaluation.

The term “storage device” refers to a hardware element, such as a database system, a file system, or another persistent storage apparatus, that stores rule information, case information, and other data used by the processor.

The term “generative AI model” refers to a machine-learned model implemented in software on a computing platform, which receives an input including a prompt sentence and generates a natural-language or structured response by probabilistic inference based on learned parameters.

The term “prompt sentence” refers to text data that includes instructions, context, and user information, and that is provided as an input to the generative AI model to cause the generative AI model to perform a specific analysis or generation task.

The term “response data” refers to output data generated by the generative AI model in response to a prompt sentence, including natural-language text and, optionally, structured fields representing analysis results.

The term “evaluation criterion” refers to one or more rules, thresholds, scoring functions, or decision conditions used by the processor to interpret the response data and to determine a possibility of a compliance violation.

The term “compliance violation” refers to behavior, an action, or a planned action that is inconsistent with, or contrary to, rule information, legal requirements, or organizational policies.

The term “emotion analysis” refers to processing performed on character information to estimate an emotional state of a user, such as anxiety, stress, confidence, or neutrality, based on linguistic features or learned models.

The term “emotional state” refers to a representation of a user's emotion, expressed as one or more categories, scores, or labels, that is estimated from the character information by emotion analysis.

The term “warning information” refers to output data that indicates a risk or a potential compliance violation and that urges caution or reconsideration by the user with respect to a planned or ongoing action.

The term “guidance information” refers to output data that provides suggestions, recommendations, or alternative actions to the user in order to avoid or mitigate a compliance violation.

The term “output message” refers to a data structure including warning information, guidance information, explanations, and related content, which is generated by the processor and transmitted to the user terminal for presentation.

The term “determination result” refers to information indicating an outcome of an evaluation of the possibility of a compliance violation, including one or more of a violation flag, a risk level, and explanatory data.

The term “final action information” refers to data indicating how the user ultimately acted in response to the output message, such as canceling an action, modifying content, or proceeding without change.

The term “learning data” refers to a collection of data items, including character information, determination results, emotional states, and final action information, that is used to train or update a generative AI model or another machine learning model.

The term “machine learning model” refers to a computational model implemented in software that is trained using learning data to perform tasks such as classification, prediction, similarity assessment, or emotion estimation.

The term “structured response” refers to response data formatted according to a predefined schema, such as a set of fields representing violation presence information, risk level information, explanation information, and recommended action information.

The term “violation presence information” refers to information within a structured response that indicates whether a compliance violation is present, absent, or uncertain.

The term “risk level information” refers to information within a structured response that represents a degree of risk associated with a compliance violation, such as low, medium, or high.

The term “explanation information” refers to information within a structured response that describes reasons, grounds, or contextual factors for an evaluation of a compliance violation.

The term “recommended action information” refers to information within a structured response that describes one or more actions advised to the user to prevent, mitigate, or respond to a compliance violation.

The term “unsent message information” refers to character information that has been input by a user at the user terminal but has not yet been finalized or transmitted to an external communication destination.

The term “operation information” refers to data representing user operations or intended actions at the user terminal, including editing actions, selection actions, transmission operations, or other interaction events.

The term “inline warning” refers to warning information that is presented directly within or adjacent to a user interface element into which the user is entering character information or performing an operation, before the character information or operation is finalized.

The term “transmission suppression instruction” refers to information that instructs or prompts the user terminal to delay, block, or request confirmation of transmission of character information based on a determination result.

In one embodiment, a server cooperates with one or more user terminals to implement the claimed system. Server includes a processor, a main memory, a non-volatile storage device, and a network interface. Terminal includes a processor, a memory, a display, an input device, and a communication interface. Server and terminal communicate over a communication network such as the Internet using a transport protocol such as HTTPS.

Server executes a program stored in the memory to implement the functions described in the claims. The program is implemented, for example, using an interpreter or runtime of a general-purpose programming language. The program controls server so that server performs natural language preprocessing, feature extraction, database querying, prompt sentence generation, communication with a generative AI model, response parsing, rule-based evaluation, emotion analysis, warning generation, and learning data management.

Server stores rule information and case information in a storage device. Rule information is stored in a database as records including identifiers, textual descriptions of organizational rules, and metadata such as rule type and applicability conditions. Case information is stored as records including descriptions of past violation events, labels indicating severity, and outcome information. Server also stores trained model parameters of a generative AI model and one or more auxiliary machine learning models, such as a text embedding model and an emotion classification model.

Server executes a natural language preprocessing module that uses a text processing library to normalize character information received from terminal. Server converts text to a standardized encoding, performs Unicode normalization, performs tokenization into words or subword units, and segments text into sentences. Server removes or marks extraneous symbols and applies stemming or lemmatization. Server generates feature information such as token sequences, n-grams, part-of-speech tags, named entities, and numerical vector representations (embeddings) by passing tokens through a feature extraction component.

Server executes a feature extraction component that may rely on a neural network model trained for representation learning. For example, server uses a bidirectional transformer encoder implemented with a deep learning framework to convert tokens into contextual embeddings. Server uses these embeddings as feature information for subsequent database retrieval and similarity computation. Server stores the feature information in the memory or in a temporary cache.

Server executes a rule retrieval module that searches rule information stored in a database. Server constructs structured queries using feature information. Server may perform exact keyword matching, fuzzy search, or embedding-based nearest neighbor search to identify rules relevant to the input. Server retrieves rule records and stores their identifiers and text in an internal data structure associated with the current request.

Server executes a case retrieval module that searches case information. Server uses feature information to compute similarity scores between the current input and stored case descriptions. Server may use a similarity function such as cosine similarity between embedding vectors produced by a neural embedding model. Server ranks cases according to similarity and selects one or more cases above a threshold. Server stores the selected case information in a data structure.

Server executes an emotion analysis module that estimates an emotional state of the user from character information. In one variant, server uses an external sentiment analysis service. In another variant, server uses a locally hosted neural network classifier. For example, server uses a recurrent neural network or transformer model that receives a sequence of token indices and outputs a vector of emotion scores corresponding to categories such as anxiety, confidence, frustration, or neutrality. Server applies a softmax function to a final layer output to obtain probability values. Server determines the emotional state by selecting the category with the highest probability or by applying a threshold rule. Server records the emotional state as part of the processing context.

Server constructs a prompt sentence to be provided to a generative AI model. Server uses a prompt generation module that combines templates with dynamic content. Server inserts the original character information, summaries of rule information, summaries of case information, and emotion-related instructions into a text prompt. Server uses a consistent structure for the prompt so that the generative AI model produces responses conforming to an expected schema. For example, server may generate a prompt sentence such as:

“You are a compliance evaluation engine. Evaluate whether the following action violates organizational rules and classify the result. Output the result in the following format:
is_violation: YES or NO or UNCERTAIN
risk_level: LOW or MEDIUM or HIGH
explanation: [short explanation]
recommendation: [short recommendation]

Action: ‘I am considering providing customer information to an external partner company.’”

In another example, server may generate a prompt sentence such as:

“Based on internal security policies and past violation cases, evaluate the compliance risk of the following action. The user appears anxious, so provide a clear and concise explanation.

Action: ‘I want to post internal project details on SNS.’”

In another example, server may generate a prompt sentence such as:

“You are a corporate compliance advisor. Analyze the following draft message for a group chat. Identify whether it could violate workplace conduct rules and suggest a safer alternative.

Message: ‘This colleague is useless; they always mess up.’”

Server transmits the prompt sentence and related parameters to a generative AI model. In one implementation, server sends an API request over the network to an external computing system that executes the generative AI model on specialized hardware such as graphics processors or tensor accelerators. In another implementation, server executes the generative AI model locally using a hardware accelerator. The generative AI model is, for example, a transformer-based language model comprising multiple self-attention layers, feed-forward layers, and layer normalization units. The model stores parameters including weight matrices and bias vectors learned from large-scale text corpora.

Server receives response data from the generative AI model. Server uses a response parsing module that interprets the response according to the format specified in the prompt sentence. When the response contains structured labels, server extracts values such as “is_violation”, “risk_level”, “explanation”, and “recommendation” by parsing delimiters or by pattern matching. When the response is not fully structured, server applies additional natural language parsing to map the text into structured fields.

Server uses a rule evaluation module to combine the structured response data with rule information and case information. Server may apply a rule engine implemented as a set of logical expressions or a decision table. For example, server may assign numeric scores to rule violations indicated in rule information and compute an aggregate risk score that is adjusted based on the generative AI model's risk level and the similarity scores to past cases. Server applies threshold-based decision criteria to determine a final violation likelihood and a final risk category. This process uses both probabilistic outputs from the generative AI model and deterministic rule comparisons against stored rules, which differs from human subjective judgment and uses machine-computable rules and data structures.

Server uses an output generation module to construct warning information and guidance information. Server selects output content based on the final determination and the emotional state. When the emotional state corresponds to anxiety, server adjusts the wording to be more explanatory and supportive. When the emotional state corresponds to overconfidence, server emphasizes potential negative outcomes and references highly similar past cases. Server may optionally request the generative AI model to rewrite an explanation segment by supplying another prompt sentence, such as:

“Rewrite the following compliance explanation for a user who appears anxious. Use simple language and provide step-by-step guidance, without changing the technical meaning. [explanation text]”

Server then composes a final message that includes a brief title, a risk indication, an explanation, and concrete recommended actions. Server transmits the message to terminal as structured data.

Terminal receives the structured data and renders a user interface. Terminal displays the risk level using visual cues such as colors and icons, displays the explanation as text, and provides controls allowing user to cancel or modify an intended action. Terminal may display the information in a modal dialog, a tooltip, or an inline annotation adjacent to the text field where user is entering character information. This interface presentation uses the structured fields produced by the server's processing pipeline.

Server records learning data into a storage device. Server stores character information, feature information, rule identifiers, case identifiers, emotional state labels, generative AI model responses, final determination results, and final action information indicating whether user changed behavior. Server uses this stored data when retraining or fine-tuning models. For example, server uses a supervised learning algorithm such as stochastic gradient descent to update parameters of a classifier that predicts violation likelihood based on feature information. Server defines a loss function such as cross-entropy between predicted classes and labels derived from determination results or actual outcomes. Server computes gradients of the loss function with respect to model parameters using backpropagation and updates weights using a learning rate schedule. Server may also use data augmentation techniques such as paraphrasing text or injecting noise to increase robustness.

Server thereby improves computer operation in several technical respects. Server converts unstructured natural language input into structured intermediate representations that are consumed by multiple modules, including rule engines and similarity models. This architecture reduces the need for repeated parsing and re-interpretation of free-text responses and enables efficient reuse of computation, thus reducing processing time. Server uses embedding-based retrieval for rule information and case information, which allows high-dimensional similarity search with sub-linear indexing structures, improving retrieval speed and accuracy compared to naive keyword search. Server uses a consistent prompt sentence structure to force the generative AI model to output compact, schema-aligned information. This reduces response size, decreases network bandwidth consumption between server and the generative AI execution environment, and simplifies parsing logic.

Server integrates the generative AI model's probabilistic outputs with deterministic rule evaluations in a single decision pipeline. This combination yields higher accuracy and reduced false positives compared to pure rule-based systems or pure generative analysis, because the system can cross-validate results from independent computational mechanisms. Server also uses emotion analysis not as a mere user-experience feature, but as an input to the message composition algorithm that controls how much detail to include and how strongly to emphasize risk, which improves user comprehension and reduces repeated queries, indirectly lowering load on server.

Server supports real-time processing of unsent character information and operation information. When terminal transmits partial text during editing, server reuses cached feature information and retrieval results to rapidly generate updated prompt sentences and decisions, rather than recomputing from scratch. This reduces latency and allows inline warnings that appear before user finalizes an action. As a result, server not only automates human review but enables a new mode of interaction—continuous, low-latency compliance evaluation tied to text editing events—that is not feasible with manual processes.

Server uses specific algorithms and data structures to implement the above behavior. In one implementation, server divides the program into modules including a preprocessing module, a retrieval module, a generative prompting module, an evaluation module, an emotion module, and a training module. Each module maintains well-defined input and output data structures. For example, the preprocessing module outputs token arrays and embedding matrices; the retrieval module outputs lists of rule identifiers and case identifiers with similarity scores; the generative prompting module outputs prompt sentence strings; the evaluation module outputs determination results; the emotion module outputs numeric emotion scores; and the training module updates parameter arrays stored in memory. This modular and structured data flow differs from a simple pipeline that only forwards text strings and allows the system to perform optimization at each stage.

Server can employ different neural network architectures in alternative embodiments. For the generative AI model, server may use an encoder-decoder transformer, a decoder-only transformer, or another autoregressive neural network. For feature extraction, server may use a convolutional neural network applied to character sequences or word sequences. For emotion classification, server may use a recurrent neural network with gated units. For retrieval of rules and cases, server may use approximate nearest neighbor search indexes. In each case, server uses parameters trained on corpora that include domain-specific compliance texts and past interaction logs, and server refines the parameters over time using learning data accumulated by the system itself.

Server thus implements specific computational mechanisms that improve technical performance, such as reducing processing latency for real-time evaluation, increasing accuracy of compliance risk detection through multi-source analysis, and reducing communication overhead by structuring prompt sentences and responses. These mechanisms go beyond merely automating a human's mental steps, because they rely on numerical optimization, vector-space retrieval, and standardized schema-driven interaction with a generative AI model, which are not available to human reviewers. The use of a generative AI model is not limited to replacing human judgment; instead, server uses particular prompt sentence designs, structured response formats, and integration with rule and case data to create a composite decision process that a human could not efficiently reproduce without the described computer architecture.

In another embodiment, server may operate in a distributed environment where separate physical machines host the generative AI model, the databases, and various processing modules. In such a configuration, server coordinates data exchange and caching to minimize network traffic and to localize repeated computations. For example, server may cache feature information and partial evaluation results for a limited time while user is composing text, thus minimizing recomputation. In a further embodiment, server may also control access policies on terminal, such as disabling a send button or masking sensitive text when a high-risk determination is returned, thereby establishing a direct control effect on a physical user interface device and providing a clear technical application beyond abstract evaluation.

By organizing the described modules, neural architectures, prompt sentences, and data flows, server achieves a concrete improvement in the way computer systems process natural-language compliance-related inputs, providing structured, adaptive, and self-improving evaluations that are implemented through specific technical means.

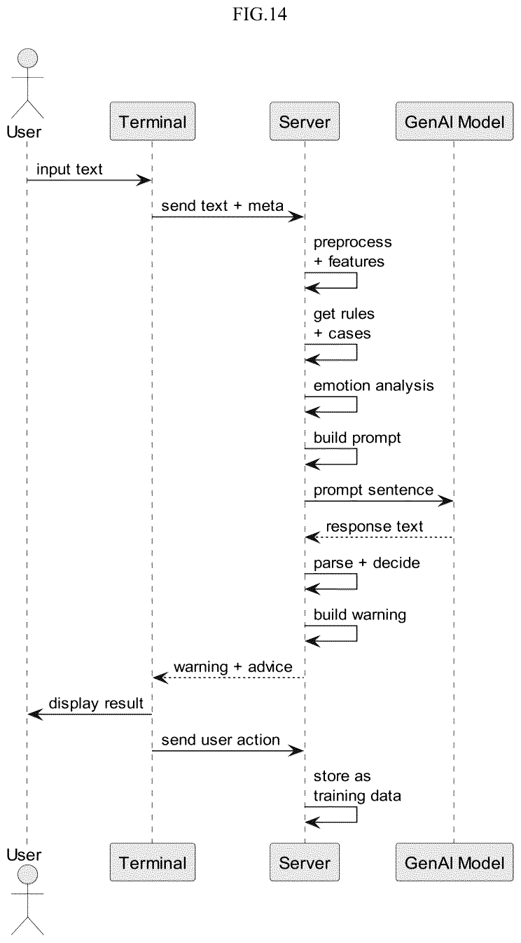

The following describes the processing flow using FIG. 14.

### Step 1

User inputs character information on the terminal.

User operates a keyboard, touch panel, or voice input interface of the terminal and enters natural-language character information describing an intended or ongoing action, such as “I am considering providing customer information to an external partner company.” or “I want to post internal project details on SNS.”. Terminal receives this input as a text string encoded in a character set (for example, UTF-8) and associates metadata such as user identifier, application context, and timestamp.

Input: raw character information and metadata entered by user.

Output: a structured request object on the terminal containing the text string and metadata, ready to be transmitted to the server.

### Step 2

Terminal transmits the request object to the server.

Terminal establishes a secure communication session, for example using HTTPS, and sends an API request including the request object to a predefined endpoint of the server. Terminal serializes the text and metadata into a data format such as JSON and includes it in the body of the request.

Input: structured request object containing character information and metadata.

Output: a network message containing the serialized request, delivered to the server via the communication network.

### Step 3

Server receives and stores the raw character information.

Server accepts the incoming network message via a network interface, deserializes the JSON payload, and extracts fields such as user identifier, character information, and timestamp. Server writes these fields into a persistent storage device, such as a relational database, in a table that logs user queries. Server assigns an internal request identifier and associates this identifier with the stored record.

Input: network message containing serialized character information and metadata.

Output: a stored log record in the database and an in-memory processing context including the request identifier, character information, and metadata.

### Step 4

Server performs preprocessing and feature extraction on the character information.

Server invokes a natural language preprocessing module implemented using a text processing library. Server normalizes the text (for example, converting to lowercase, performing Unicode normalization), tokenizes the text into words or subword units, and splits the text into sentences. Server removes or flags unnecessary whitespace and control characters. Server then passes the tokenized sequence to a feature extraction model, such as a transformer-based encoder implemented in a machine learning framework, to compute embedding vectors representing the semantic content of the text. Server may also compute additional features including part-of-speech tags, named entities, and n-gram frequencies.

Input: raw character information from the processing context.

Output: feature information, including token sequences, embeddings, and extracted linguistic attributes, stored in the processing context.

### Step 5

Server retrieves rule information relevant to the feature information.

Server executes a rule retrieval module that constructs database queries using keywords and entities extracted from the feature information. Server performs SQL queries or embedding-based similarity searches against a rule information table stored in a storage device. Server identifies rule records whose text or embeddings are similar to the feature information according to a similarity metric such as cosine similarity. Server retrieves these rule records and compiles them into a list ordered by relevance.

Input: feature information (tokens, embeddings, keywords) from Step 4.

Output: a set of rule information entries, each containing rule identifiers and textual descriptions, associated with the current request context.

### Step 6

Server retrieves case information relevant to the feature information.

Server invokes a case retrieval module that accesses a case information table storing descriptions of past events. Server computes similarity measures between the embedding of the current character information and embeddings of stored case descriptions. Server selects case records with similarity scores above a threshold or within a top-N ranking. Server extracts case identifiers, summary descriptions, severity labels, and outcomes for these selected cases.

Input: feature information from Step 4 and stored case information.

Output: a set of relevant case information entries, including similarity scores and associated metadata, stored in the processing context.

### Step 7

Server performs emotion analysis on the character information.

Server passes the preprocessed character information or its embeddings to an emotion classification model. The model may be a neural network, such as a recurrent network or transformer, trained to output probabilities for emotion categories (for example, anxiety, confidence, frustration, neutrality). Server computes a probability distribution using a softmax layer on the model's output and determines the dominant emotional state by selecting the category with the highest probability or applying threshold rules. Server also stores the numerical scores for each emotion category.

Input: preprocessed character information and embedding representations from Step 4.

Output: an estimated emotional state and associated emotion scores, added to the processing context.

### Step 8

Server generates a prompt sentence for the generative AI model.

Server executes a prompt generation module that constructs a text instruction for the generative AI model. Server selects a template based on the type of query and desired output schema, then inserts into the template the original character information, concise summaries of the retrieved rule information and case information, and, optionally, an indication of the emotional state. Server formats the prompt so that the generative AI model will output a structured response.

For example, server may generate:

“You are a compliance evaluation engine. Evaluate whether the following action violates organizational rules and classify the result. Output the result in the following format:
is_violation: YES or NO or UNCERTAIN
risk_level: LOW or MEDIUM or HIGH
explanation: [short explanation]
recommendation: [short recommendation]

Action: ‘I am considering providing customer information to an external partner company.’”

Input: character information, rule information, case information, and emotional state from previous steps.

Output: a prompt sentence string stored in the processing context for transmission to the generative AI model.

### Step 9

Server transmits the prompt sentence to the generative AI model and obtains response data.

Server invokes an interface module that sends the prompt sentence, along with configuration parameters such as model name and maximum token count, to a generative AI model execution environment. Server may send this as an API request to a remote computing system or as a function call to a locally hosted model. The generative AI model processes the prompt sentence using its internal transformer architecture and generates response data in natural language according to the instructions. Server receives the generated text as a response string.

### Input: Prompt Sentence and Configuration Parameters From Step 8.

Output: response data from the generative AI model, stored in the processing context as a text string.

### Step 10

Server parses the response data into structured fields.

Server applies a response parsing module that interprets the response data according to the format specified in the prompt sentence. Server uses string matching, regular expressions, or a parsing library to locate markers such as “is_violation:”, “risk_level:”, “explanation:”, and “recommendation:”. Server extracts the corresponding values and converts categorical values into internal codes or enumerations. Server stores these values as structured fields in the processing context.

Input: response data string from Step 9.

Output: structured response fields including violation presence information, risk level information, explanation information, and recommended action information.

### Step 11

Server computes a final determination result by combining structured response fields with rule and case information.

Server executes a rule evaluation module that receives the structured fields along with retrieved rule information and case information. Server may assign numeric weights to rule violations, risk levels, and similarity scores, then compute an aggregate risk score through arithmetic operations such as weighted sums or maximum functions. Server compares the aggregate risk score with predefined thresholds to decide a final violation likelihood and a final risk category. Server also selects which rules and cases to reference in the explanation based on the highest scores.

Input: structured response fields from Step 10, rule information from Step 5, and case information from Step 6.

Output: a determination result including a final violation flag, a final risk level, and selected explanatory rule and case references.

### Step 12

Server generates warning information and guidance information adjusted to the emotional state.

Server executes an output generation module that constructs messages for presentation to user. Server uses the determination result to decide the core content of the warning and uses the emotional state to decide tone and detail level. For an anxious emotional state, server includes more detailed explanations and step-by-step recommendations; for an overconfident emotional state, server emphasizes consequences and cites past severe cases. Server composes text segments for a warning title, a main body explanation, and recommended actions.

Input: determination result from Step 11 and emotional state from Step 7.

Output: warning information and guidance information formatted as text segments, assembled into an output message structure.

### Step 13

Server transmits the output message to the terminal.

Server packages the warning information, guidance information, risk level, and references into a structured response, for example a JSON object, and sends it via the network interface using an HTTP response. Server includes the internal request identifier so that terminal can correlate the response with the originating user action.

Input: output message structure from Step 12.

Output: a network response message containing the structured output, delivered to the terminal.

### Step 14

Terminal presents the warning information and guidance information to user.

Terminal receives the structured response from server through the communication interface and deserializes it. Terminal maps the risk level to visual indicators such as colors and icons and displays the warning title and explanation in a dialog, banner, or inline annotation adjacent to the text field where user entered the character information. Terminal also displays recommended action options, such as buttons to cancel the operation or to edit the text.

Input: structured response message from Step 13.

Output: a rendered user interface on the display showing warning information and guidance information, along with interactive controls for user.

### Step 15

User reviews the warning and decides on a final action.

User reads the information shown on the terminal display and decides whether to proceed, modify, or cancel the intended action. User may press a button to cancel sending, modify the text in the input field, or ignore the warning and proceed depending on permissions. Terminal captures the user's final action, such as “canceled,” “modified and resent,” or “sent without change,” and prepares a feedback record representing this outcome.

Input: presented warning information and guidance information, and interactive controls on the terminal.

Output: user's final action information, recorded by the terminal.

### Step 16

Terminal transmits final action information to the server.

Terminal sends a feedback message to server containing the internal request identifier and the final action information. Terminal encodes this as a structured payload, for example in JSON, and transmits it via HTTPS.

Input: final action information captured in Step 15.

Output: a network message containing final action information, delivered to the server.

### Step 17

Server stores learning data for model training and system improvement.

Server receives the feedback message and links the final action information to the previously stored log record using the request identifier. Server stores character information, feature information, structured response fields, determination result, emotional state, and final action information together as a learning data entry in a dedicated training dataset. Server may perform aggregation or anonymization operations on this dataset, then periodically uses it to update parameters of classification models or to fine-tune prompt strategies. In doing so, server computes loss values comparing model predictions to observed outcomes and updates weights using gradient-based optimization algorithms.

Input: final action information from Step 16 and stored context from earlier steps.

Output: an updated learning dataset stored in the storage device, and, when training is performed, updated model parameters for machine learning components.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

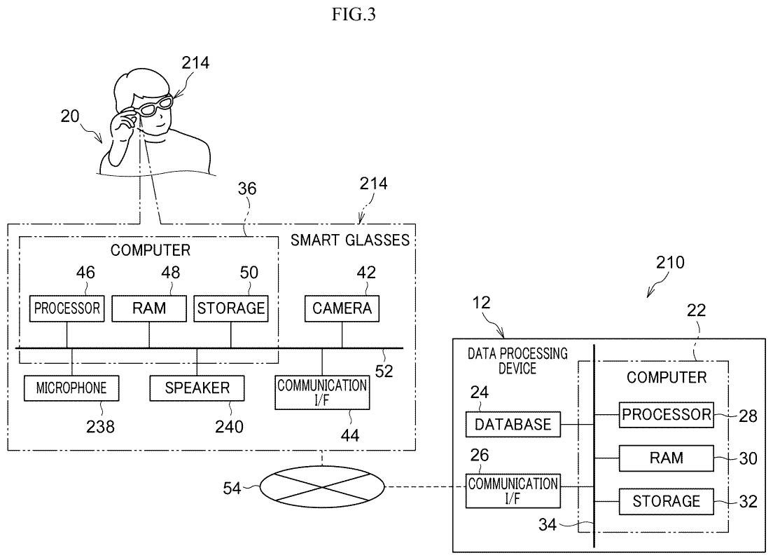

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

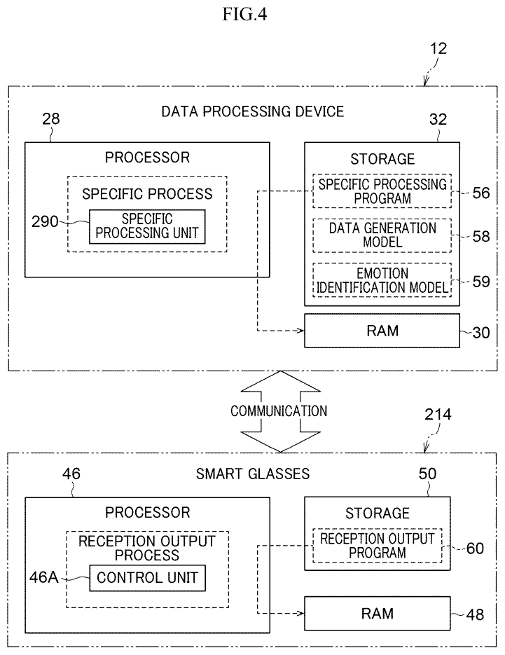

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

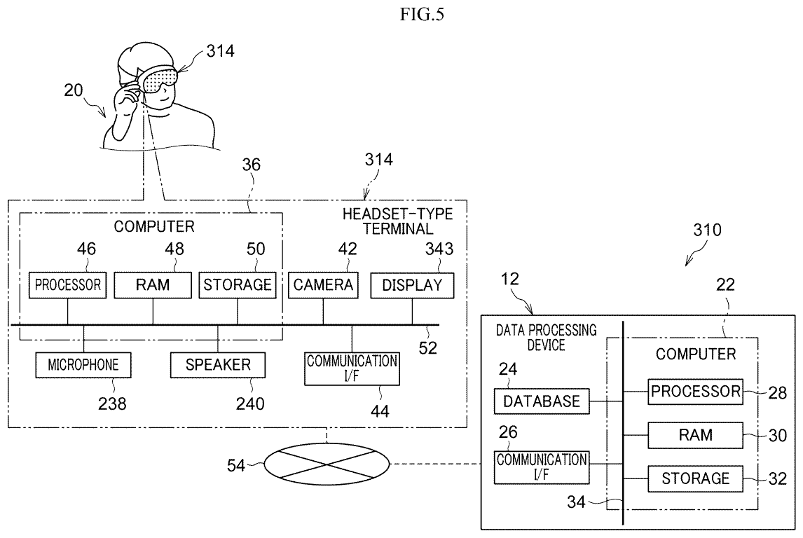

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

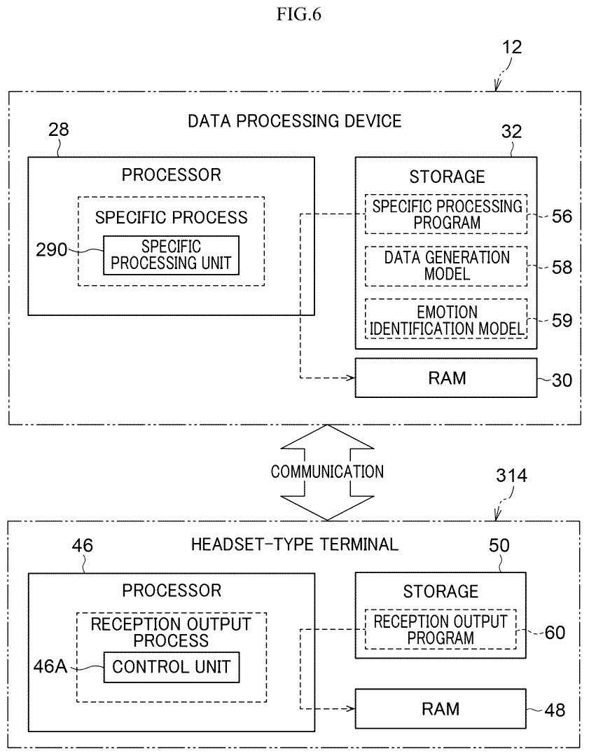

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

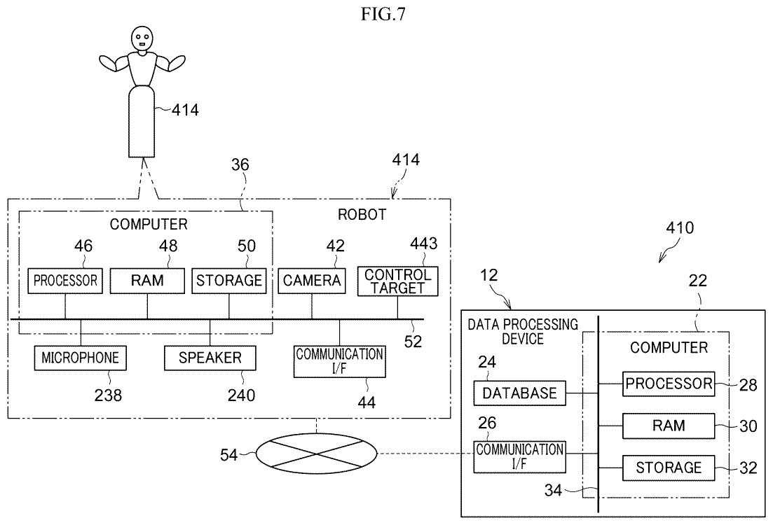

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

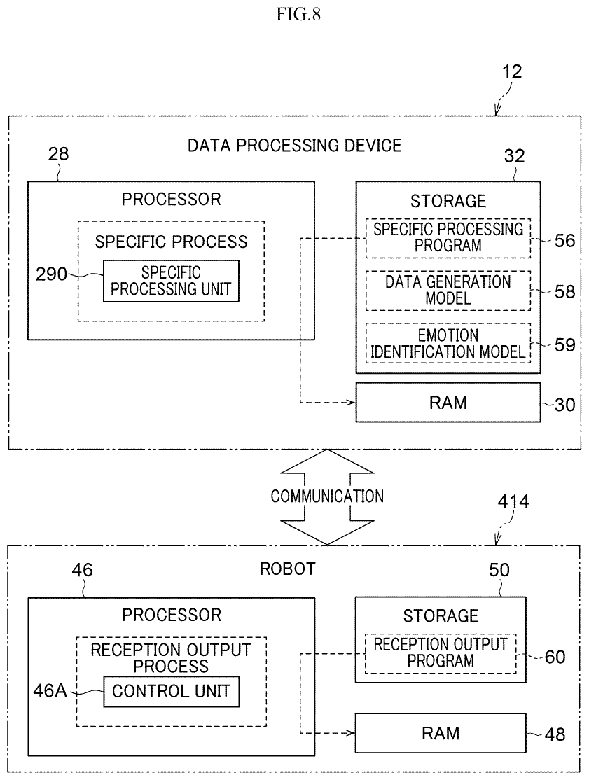

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

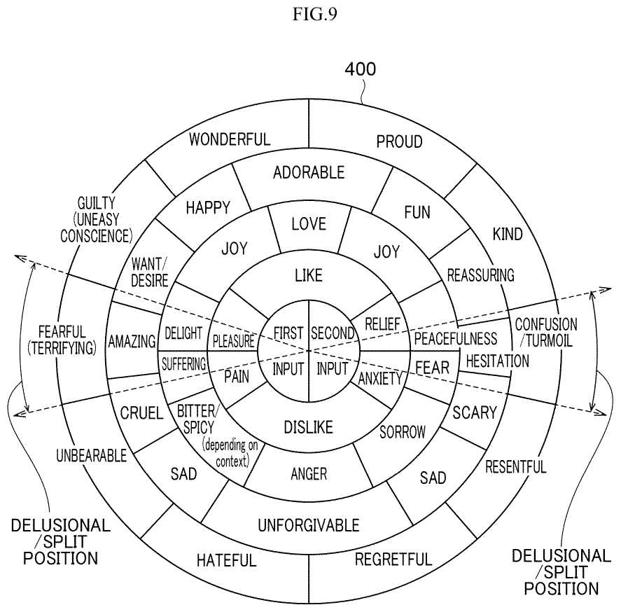

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

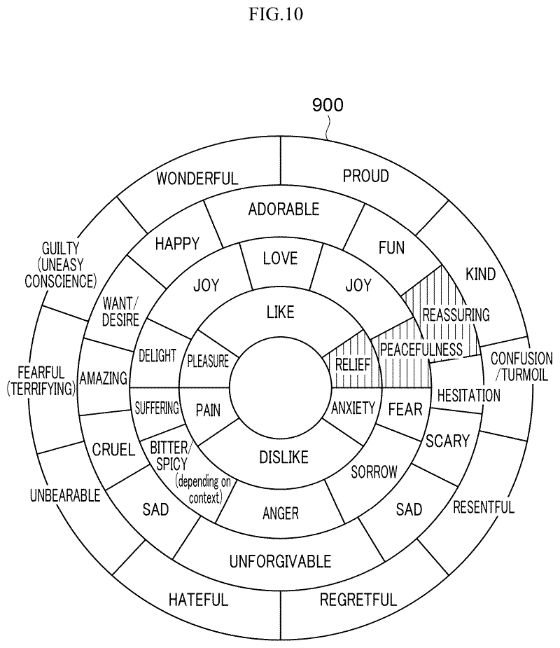

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
receive, via a communication line, situation information in text form from a user terminal,
store the situation information in association with identification information and time information in the storage device, and verify whether the situation information satisfies a predetermined input condition,
generate, based on the situation information, a prompt sentence including an evaluation request, an output format, a risk index, and a recommended action for evaluating a possibility of a compliance violation, generate input data by combining the prompt sentence with the situation information, and output the input data together with instruction information for transmission of the input data to a generative artificial intelligence model executed by an external processing device,
acquire response data from the generative artificial intelligence model, extract, from the response data, the risk index, a risk category, reason information, related policy categories, and recommended action information, perform an evaluation process for determining whether the risk index satisfies a predetermined threshold condition, search regulation information stored in a regulation information storage device based on the related policy categories, and
generate evaluation result data by adding the regulation information to the response data,
generate a feature quantity corresponding to contents of the situation information, perform a similarity calculation between the feature quantity and feature quantities of past cases stored in a case information storage device, extract past cases having a similarity satisfying a predetermined condition, and generate extended evaluation result data by adding summary information and outcome information regarding the past cases to the evaluation result data, and
convert the extended evaluation result data into user interface output data, transmit the user interface output data to the user terminal, and visually present the risk index, the risk category, the reason information, related regulation information, past case information, and the recommended action information on the user terminal.

### Supplementary 2

The system according to supplementary 1,
wherein the processor is configured to, in generating the prompt sentence, generate the prompt sentence including, in addition to a determination of presence or absence of a compliance violation regarding the situation information, an evaluation request for generation of specific violation cases to be presented when the possibility of the violation is evaluated as high, construct specific violation case information based on the response data acquired from the generative artificial intelligence model, and include the specific violation case information in the user interface output data.

### Supplementary 3

The system according to supplementary 1,
wherein the processor is configured to, in generating the prompt sentence, generate the prompt sentence including an evaluation request for presenting an appropriate countermeasure for the situation information, extract countermeasure candidate information from the response data acquired from the generative artificial intelligence model, correct or select the countermeasure candidate information based on the regulation information and the past cases to generate countermeasure information including a specific actionable response for a user, and include the countermeasure information in the user interface output data.

### Application Example 1

### Supplementary 1

A system comprising a processor,
wherein the processor is configured to
receive, from a terminal operated by a user, text data representing a situation encountered in business operations,
apply a natural language processing algorithm to the text data to generate structured information at a word level and a phrase level and to extract words and phrases related to compliance,
search, based on the extracted words and phrases, regulation information and past case information stored in a regulation information storage device, and acquire regulation information and case information related to the text data,
generate, based on the structured information and the acquired regulation information and case information, a prompt sentence including a question regarding a possibility of a compliance violation and an output format, and input the prompt sentence to a generative AI model,
analyze response data output from the generative AI model and generate an evaluation result including risk level information, violation possibility information, and recommended action information,
present the evaluation result to the user and, when the risk level information or the violation possibility information satisfies a predetermined condition, transmit notification information to an administrator notification device, and
store the text data, the structured information, the regulation information, the response data, and the evaluation result as case data in a storage device, learn or update a compliance risk determination machine learning model based on the case data and final decision information provided by an administrator, calculate a risk estimation value for the text data using the updated machine learning model, and integrate the risk estimation value with the evaluation result.

### Supplementary 2

The system according to supplementary 1,
wherein the processor is configured to
generate the prompt sentence so as to include summary information of organizational regulations corresponding to the text data and the risk estimation value calculated by the compliance risk determination machine learning model, and to specify to the generative AI model an output format including an evaluation of the possibility of a compliance violation, a reasoning, and a recommended action.

### Supplementary 3

The system according to supplementary 1,
wherein the processor is configured to
include, in the prompt sentence, a specification of a structured output format including the risk level information, the violation possibility information, reasoning information, and the recommended action information, and to analyze the response data from the generative AI model based on the structured output format.

### Example 2

### Supplementary 1

A system comprising a processor,
wherein the processor is configured to
receive, from a user terminal, input data including natural language information related to compliance,
tokenize the input data by using a natural language processing algorithm, extract important expressions, action contents, and situation information from the tokenized input data, and
specify an action type to be evaluated for compliance and a risk factor,
generate prompt data including a prompt sentence that instructs a generative AI model to perform a compliance evaluation based on the specified action type and the specified risk factor, and transmit the prompt data to the generative AI model,
analyze response data obtained from the generative AI model and extract risk level information and regulation classification information from the response data,
search a regulation database that stores internal regulation information based on the action type, the risk factor, and the regulation classification information, and acquire a regulation candidate corresponding to the input data and content information of the regulation candidate,
generate evaluation data including an evaluation result regarding a possibility of a compliance violation, regulation information corresponding to the evaluation result, and
recommended response content, based on the response data and the regulation candidate, and
transmit the evaluation data to the user terminal and convert the evaluation data into a displayable format to be provided via a user interface.

### Supplementary 2

The system according to supplementary 1,
wherein the processor is configured to
generate the prompt data such that the prompt sentence instructs the generative AI model to present a similar case corresponding to the action contents and the situation information included in the input data, and to associate response data related to the similar case, obtained from the generative AI model, with the regulation candidate acquired from the regulation database, and include the associated similar case as a concrete violation example in the evaluation data.

### Supplementary 3

The system according to supplementary 1,
wherein the processor is configured to
generate the prompt data such that the prompt sentence instructs the generative AI model to present a recommended response policy based on the input data, analyze response data related to the recommended response policy obtained from the generative AI model to extract a response candidate, compare the response candidate with internal procedure information stored in the regulation database to determine consistency, and include the response candidate, as the recommended response content, in the evaluation data.

### Application Example 2

### Supplementary 1

A system comprising a processor and a memory,
wherein the processor is configured to
receive character information from a user terminal and perform preprocessing on the character information to extract feature information,
search, based on the feature information, rule information and case information stored in a storage device, and acquire rule information and case information that are associated with the character information,
generate, based on the character information and the acquired rule information and case information, a prompt sentence that instructs a generative AI model to perform a compliance evaluation, and input the prompt sentence to the generative AI model,
analyze response data obtained from the generative AI model, and determine a possibility of a compliance violation based on the response data, an evaluation criterion, and the rule information and the case information,
perform emotion analysis on the character information to estimate an emotional state of a user,
generate warning information and guidance information by adjusting content and expression of an output message according to the emotional state and a determination result of the possibility of the compliance violation, and transmit the warning information and the guidance information to the user terminal, and
accumulate, as learning data, the character information, the determination result, the emotional state, and final action information of the user, and use the learning data for training of the generative AI model or another machine learning model.

### Supplementary 2

The system according to supplementary 1,
wherein the processor is configured to
generate the prompt sentence in a format that instructs the generative AI model to output a structured response including predetermined items as the compliance evaluation result, and
extract, from the structured response, violation presence information, risk level information, explanation information, and recommended action information, and generate the determination result and the warning information based on the extracted information.

### Supplementary 3

The system according to supplementary 1,
wherein the processor is configured to
receive, in real time, unsent message information or operation information that is sequentially transmitted from the user terminal, determine the possibility of the compliance violation for the unsent message information or the operation information before the unsent message information or the operation information is finalized by using respective functions defined in supplementary 1, and cause the user terminal to display an inline warning or a transmission suppression instruction based on a determination result.

What is claimed is:

1. A system comprising:
circuitry configured to:
receive, via a packet-switched network, input data in text form from a terminal device;
generate, based on the input data, a prompt sentence including an evaluation request descriptor and an output format specification;
transmit the prompt sentence and the input data to a generative neural network model via the packet-switched network;
acquire response data from the generative neural network model and extract, from the response data, a quantitative index and classification information;
perform an evaluation process based on the quantitative index and a predetermined threshold condition;
search reference information stored in a storage device based on the classification information;
generate evaluation result data based on the response data and the reference information; and
transmit the evaluation result data to the terminal device via the packet-switched network.

2. The system according to claim 1, wherein the circuitry is further configured to store the input data in association with identification information and time information in the storage device, and to verify whether the input data satisfies a predetermined input condition before generating the prompt sentence.

3. The system according to claim 2, wherein the circuitry is further configured to generate the prompt sentence using a template mechanism in which a base prompt sentence stored in the storage device is populated with parameters derived from the input data.

4. The system according to claim 3, wherein the classification information extracted from the response data includes a category label, reason information, related classification labels, and recommended action information.

5. The system according to claim 4, wherein the circuitry is further configured to generate a feature vector corresponding to contents of the input data by processing the input data through an embedding model, and to perform a similarity calculation between the feature vector and feature vectors of past records stored in a record information storage device.

6. The system according to claim 5, wherein the similarity calculation comprises a cosine similarity computation between the feature vector and the feature vectors of the past records.

7. The system according to claim 6, wherein the circuitry is further configured to extract past records having a similarity satisfying a predetermined similarity condition, and to generate extended evaluation result data by adding summary information and outcome information of the extracted past records to the evaluation result data.

8. The system according to claim 1, wherein the prompt sentence further includes a quantitative index descriptor and a recommended action descriptor.

9. The system according to claim 1, wherein the generative neural network model is executed by an external processing apparatus, and the circuitry transmits the prompt sentence and the input data to the external processing apparatus via an application programming interface over the packet-switched network.

10. The system according to claim 1, wherein the circuitry is further configured to validate a format of the response data and, when the response data does not satisfy a predetermined format condition, re-issue a modified prompt sentence to the generative neural network model.

11. The system according to claim 1, wherein the circuitry is further configured to convert the evaluation result data into user interface output data and transmit the user interface output data to the terminal device for visual presentation.

12. The system according to claim 1, wherein the circuitry is further configured to generate, based on the input data, a second prompt sentence instructing the generative neural network model to generate a case example, and to acquire second response data from the generative neural network model and cause the case example to be displayed via a user interface of the terminal device.

13. The system according to claim 1, wherein the circuitry is further configured to generate, based on the input data, a third prompt sentence instructing the generative neural network model to propose a recommended action, and to acquire third response data from the generative neural network model and generate the recommended action based on the third response data.

14. The system according to claim 1, wherein the circuitry is further configured to perform natural language processing on the input data to extract feature information including action type information and risk factor information, and to generate the prompt sentence based on the feature information.

15. The system according to claim 1, wherein the circuitry is further configured to perform emotion analysis on the input data to estimate an emotional state of a user of the terminal device, and to adjust content of the evaluation result data according to the estimated emotional state.

16. The system according to claim 15, wherein the circuitry is further configured to accumulate, as learning data, the input data, the evaluation result data, the estimated emotional state, and action information of the user, and to use the learning data for training of the generative neural network model.

17. The system according to claim 1, wherein the evaluation process comprises determining a possibility of a compliance violation, the quantitative index comprises a risk index, and the classification information comprises a risk category and related policy categories.

18. A system comprising:
circuitry configured to:
receive, via a packet-switched network, input data in text form from a terminal device;
store the input data in association with identification information and time information in a storage device;
verify whether the input data satisfies a predetermined input condition;
generate, based on the input data, a prompt sentence including an evaluation request descriptor, an output format specification, a quantitative index descriptor, and a recommended action descriptor, by populating a base prompt sentence stored in the storage device with parameters derived from the input data;
transmit the prompt sentence and the input data to a generative neural network model via the packet-switched network;
acquire response data from the generative neural network model and extract, from the response data, a quantitative index, a category label, reason information, related classification labels, and recommended action information;
perform an evaluation process for determining whether the quantitative index satisfies a predetermined threshold condition;
search reference information stored in the storage device based on the related classification labels;
generate evaluation result data by adding the reference information to the response data;
generate a feature vector corresponding to contents of the input data by processing the input data through an embedding model;
perform a cosine similarity calculation between the feature vector and feature vectors of past records stored in the storage device;
extract past records having a similarity satisfying a predetermined similarity condition;
generate extended evaluation result data by adding summary information and outcome information of the extracted past records to the evaluation result data;
convert the extended evaluation result data into user interface output data; and
transmit the user interface output data to the terminal device via the packet-switched network.

19. The system according to claim 18, wherein the circuitry is further configured to validate a format of the response data and, when the response data does not satisfy a predetermined format condition, re-issue a modified prompt sentence to the generative neural network model.

20. A method performed by a system comprising circuitry, the method comprising:
receiving, via a packet-switched network, input data in text form from a terminal device;
generating, by the circuitry and based on the input data, a prompt sentence including an evaluation request descriptor and an output format specification;
transmitting the prompt sentence and the input data to a generative neural network model via the packet-switched network;
acquiring response data from the generative neural network model and extracting, from the response data, a quantitative index and classification information;
performing an evaluation process based on the quantitative index and a predetermined threshold condition;
searching reference information stored in a storage device based on the classification information;
generating evaluation result data based on the response data and the reference information; and
transmitting the evaluation result data to the terminal device via the packet-switched network.
